(19) United States
(12) Patent Application Publication
(10) Pub. No.: US 2017/0170937 A1
(43) Pub. Date: Jun. 15, 2017

(54) METHOD FOR MULTI-USER UPLINK DATA TRANSMISSION IN WIRELESS COMMUNICATION SYSTEM AND DEVICE THEREFOR

(71) Applicant: LG ELECTRONICS INC., Seoul (KR)

(72) Inventors: Jinyoung CHUN, Seoul (KR); Kiseon RYU, Seoul (KR); Wookbong LEE, Seoul (KR); Hangyu CHO, Seoul (KR); Suhwook KIM, Seoul (KR)

(73) Assignee: LG ELECTRONICS INC., Seoul (KR)

(21) Appl. No.: 15/322,062

(22) PCT Filed: Jan. 29, 2015
(86) PCT No.: PCT/KR2015/000996

§ 371 Date: Dec. 23, 2016

Related U.S. Application Data
(60) Provisional application No. 62/017,821, filed on Jun. 26, 2014.

(51) Int. Cl. H04L 5/00

(52) U.S. Cl. CPC H04L 5/0048; H04L 5/0094

(57) ABSTRACT

Disclosed are a method for transmitting multi-user uplink data in a wireless communication system and a device therefor. In detail, a method for transmitting multi-user uplink data in a wireless communication system, includes: receiving, by a station (STA), a sounding request frame from an access point (AP); and transmitting, by the STA, a sounding frame to the AP in response to the sounding request frame, wherein the sounding request frame may include information indicating the number of streams in which the STA needs to transmit the sounding frame, and the sounding frame may include a long training field (LTF) symbols as many as the number of streams.

### TECHNICAL FIELD

The present invention relates to a wireless communication system, and more particularly, to a method for supporting uplink data transmission of multi-users and a device for supporting the same.

### BACKGROUND ART

Wi-Fi is a wireless local area network (WLAN) technology which enables a device to access the Internet in a frequency band of 2.4 GHz, 5 GHz or 6 GHz.

A WLAN is based on the institute of electrical and electronic engineers (IEEE) 802.11 standard. The wireless next generation standing committee (WNG SC) of IEEE 802.11 is an ad-hoc committee which is worried about the next-generation wireless local area network (WLAN) in the medium to longer term.

IEEE 802.11n has an object of increasing the speed and reliability of a network and extending the coverage of a wireless network. More specifically, IEEE 802.11n supports a high throughput (HT) providing a maximum data rate of 600 Mbps. Furthermore, in order to minimize a transfer error and to optimize a data rate, IEEE 802.11n is based on a multiple inputs and multiple outputs (MIMO) technology in which multiple antennas are used at both ends of a transmission unit and a reception unit.

As the spread of a WLAN is activated and applications using the WLAN are diversified, in the next-generation WLAN system supporting a very high throughput (VHT), IEEE 802.11ac has been newly enacted as the next version of an IEEE 802.11n WLAN system. IEEE 802.11ac supports a data rate of 1 Gbps or more through 80 MHz bandwidth transmission and/or higher bandwidth transmission (e.g., 160 MHz), and chiefly operates in a 5 GHz band.

Recently, a need for a new WLAN system for supporting a higher throughput than a data rate supported by IEEE 802.11ac comes to the fore.

The scope of IEEE 802.11ax chiefly discussed in the next-generation WLAN study group called a so-called IEEE 802.11ax or high efficiency (HEW) WLAN includes 1) the improvement of an 802.11 physical (PHY) layer and medium access control (MAC) layer in bands of 2.4 GHz, 5 GHz, etc., 2) the improvement of spectrum efficiency and area throughput, 3) the improvement of performance in actual indoor and outdoor environments, such as an environment in which an interference source is present, a dense heterogeneous network environment, and an environment in which a high user load is present and so on.

A scenario chiefly taken into consideration in IEEE 802.11ax is a dense environment in which many access points (APs) and many stations (STAs) are present. In IEEE 802.11ax, the improvement of spectrum efficiency and area throughput is discussed in such a situation. More specifically, there is an interest in the improvement of substantial performance in outdoor environments not greatly taken into consideration in existing WLANs in addition to indoor environments.

In IEEE 802.11ax, there is a great interest in scenarios, such as wireless offices, smart homes, stadiums, hotspots, and buildings/apartments. The improvement of system performance in a dense environment in which many APs and many STAs are present is discussed based on the corresponding scenarios.

In the future, it is expected in IEEE 802.11ax that the improvement of system performance in an overlapping basic service set (OBSS) environment, the improvement of an outdoor environment, cellular offloading, and so on rather than single link performance improvement in a single basic service set (BSS) will be actively discussed. The directivity of such IEEE 802.11ax means that the next-generation WLAN will have a technical scope gradually similar to that of mobile communication. Recently, when considering a situation in which mobile communication and a WLAN technology are discussed together in small cells and direct-to-direct (D2D) communication coverage, it is expected that the technological and business convergence of the next-generation WLAN based on IEEE 802.11ax and mobile communication will be further activated.

### DETAILED DESCRIPTION OF INVENTION

### Technical Problem

An object of the present invention is to propose an uplink multi-user transmission method in a wireless communication system.

Further, an object of the present invention is to propose a pre-procedure for acquiring channel state information and/or buffer state information for uplink multi-user transmission in the wireless communication system.

In addition, an object of the present invention is to propose a frame structure for the uplink multi-user transmission in the wireless communication system.

The objects of the present invention are not limited to the technical objects described above, and other technical objects not mentioned herein may be understood to those skilled in the art from the description below.

### Technical Solution

According to one aspect of the present invention, a method for transmitting multi-user uplink data in a wireless communication system, includes: receiving, by a station (STA), a sounding request frame from an access point (AP); and transmitting, by the STA, a sounding frame to the AP in response to the sounding request frame, wherein the sounding request frame may include information indicating the number of streams in which the STA needs to transmit the sounding frame, and the sounding frame may include a long training field (LTF) symbols as many as the number of streams.

According to another aspect of the present invention, a station (STA) device for transmitting multi-user uplink data in a wireless communication system, includes: a radio frequency (RF) unit for transmitting/receiving a wireless signal; and a processor, wherein the processor may be configured to receive a sounding request frame from an access point (AP), and transmit a sounding frame to the AP in response to the sounding request frame, the sounding request frame may include information indicating the number of streams in which the STA needs to transmit the sounding frame, and the sounding frame may include a long training field (LTF) symbols as many as the number of streams.

Preferably, the sounding request frame may include information for the sounding request frame to indicate a sounding request for transmitting uplink data.

Preferably, the sounding request frame may include information for indicating the sounding request for the uplink data transmission in a Modulation and Coding Scheme (MCS) feedback request (MRQ) subfield of a VHT control field.

Preferably, the sounding request frame may include information for indicating the sounding request for the uplink data transmission in a Sounding Dialog Token field.

Preferably, the sounding frame may be constituted only by a High Efficiency STF (HE-STF), a High Efficiency LTF (HE-LTF), and a High Efficiency SIGNAL (HE-SIG) except for a Legacy-Short Training Field (L-STF), a Legacy-Long Training Field (L-LTF), and a Legacy SIGNAL (L-SIG) field.

Preferably, the sounding request frame may include information for requesting buffer status information of the STA, and the sounding frame may include the buffer status information of the STA.

Preferably, the buffer status information may include at least one information of access category (AC) of uplink data to be transmitted by the STA, the size of the uplink data, the size of a queue in which the uplink data are accumulated, a backoff count for the uplink data transmission, and a contention window for the uplink data transmission.

Preferably, the sounding request frame may be a Null Data Packet Announcement (NDPA) frame.

Preferably, the sounding frame may be a Null Data Packet (NDP).

According to yet another aspect of the present invention, a method for transmitting multi-user uplink data in a wireless communication system, includes: transmitting, by an access point (AP), a sounding request frame to a station (STA) which participates in transmitting the multi-user uplink data; and receiving, by the AP, a sounding frame from the STA in response to the sounding request frame, wherein the sounding request frame may include information indicating the number of streams in which the STA needs to transmit the sounding frame, and the sounding frame may include long training fields (LTFs) as many as the number of streams.

According to still yet another aspect of the present invention, an access point (AP) device for transmitting multi-user uplink data in a wireless communication system, includes: a radio frequency (RF) unit for transmitting/receiving a wireless signal; and a processor, wherein the processor may be configured to transmit a sounding request frame to a plurality of stations (STAs) which participate in transmitting the multi-user uplink data, and receive a sounding frame from the STA in response to the sounding request frame, the sounding request frame may include information indicating the number of streams in which the STA needs to transmit the sounding frame, and the sounding frame may include long training fields (LTFs) as many as the number of streams.

Preferably, the method for transmitting multi-user uplink data may further include: transmitting, by the AP, a polling frame to a second STA which participates in transmitting the multi-user uplink data in order to request transmitting the sounding frame; and receiving, by the AP, the sounding frame from the second STA in response to the polling frame.

Preferably, the method for transmitting multi-user uplink data may further include allocating, by the AP, an uplink radio resource to the STA based on uplink channel information measured through the sounding frame.

### Advantageous Effects

According to embodiments of the present invention, uplink multi-user transmission can be performed through respective different spatial streams or frequency resources in a wireless communication system.

Further, according to the embodiments of the present invention, the uplink multi-user transmission can be smoothly performed based on channel state information and/or buffer state information for the uplink multi-user transmission in the wireless communication system.

In addition, according to the embodiments of the present invention, the uplink multi-user transmission can be smoothly performed based on a frame structure for the uplink multi-user transmission in the wireless communication system.

The technical effects of the present invention are not limited to the technical effects described above, and other technical effects not mentioned herein may be understood to those skilled in the art from the description below.

### DESCRIPTION OF DRAWINGS

The accompanying drawings, which are included herein as a part of the description for help understanding the present invention, provide embodiments of the present invention, and describe the technical features of the present invention with the description below.

FIG. 1 is a diagram illustrating an example of IEEE 802.11 system to which the present invention may be applied.

FIG. 2 is a diagram exemplifying a structure of layer architecture in IEEE 802.11 system to which the present invention may be applied.

FIG. 3 exemplifies a non-HT format PPDU and an HT format PPDU of a wireless communication system to which the present invention may be applied.

FIG. 4 exemplifies a VHT format PPDU of a wireless communication system to which the present invention may be applied.

FIG. 5 is a diagram exemplifying a constellation for distinguishing a format of PPDU in a wireless communication system to which the present invention may be applied.

FIG. 6 exemplifies a MAC frame format in IEEE 802.11 system to which the present invention may be applied.

FIG. 7 is a diagram illustrating a frame control field in an MAC frame in the wireless communication system to which the present invention may be applied.

FIG. 8 is a diagram for exemplifying a predetermined back-off period and a frame transmission procedure in the wireless communication system to which the present invention can be applied.

FIG. 9 is a diagram illustrating an IFS relationship in the wireless communication system to which the present invention may be applied.

FIG. 10 illustrates a VHT format of an HT control field in the wireless communication system to which the present invention may be applied.

FIG. 11 is a diagram for conceptually describing a channel sounding method in the wireless communication system to which the present invention can be applied.

FIG. 12 is a diagram illustrating a VHT NDPA frame in the wireless communication system to which the present invention may be applied.

FIG. 13 is a diagram illustrating an NDP PPDU in the wireless communication system to which the present invention may be applied.

FIG. 14 is a diagram illustrating a VHT compressed beamforming frame format in the wireless communication system to which the present invention may be applied.

FIG. 15 is a diagram illustrating a beamforming report poll frame format in the wireless communication system to which the present invention may be applied.

FIG. 16 is a diagram illustrating a Group ID management frame in the wireless communication system to which the present invention may be applied.

FIG. 17 is a diagram illustrating a downlink multi-user PPDU format in the wireless communication system to which the present invention may be applied.

FIG. 18 is a diagram illustrating a downlink MU-MIMO transmission process in the wireless communication system to which the present invention may be applied.

FIGS. 19 to 23 are diagrams illustrating a high efficiency (HE) format PPDU according to an embodiment of the present invention.

FIG. 24 illustrates phase rotation for HE format PPDU detection according to an embodiment of the present invention.

FIG. 25 is a diagram illustrating an uplink multi-user transmission procedure according to an embodiment of the present invention.

FIG. 26 is a diagram illustrating the uplink multi-user transmission procedure according to an embodiment of the present invention.

FIG. 27 is a diagram illustrating a downlink PPDU structure associated with uplink multi-user transmission according to an embodiment of the present invention.

FIG. 28 is a diagram illustrating a pre-procedure for the uplink multi-user transmission according to an embodiment of the present invention.

FIG. 29 is a diagram illustrating a pre-procedure for the uplink multi-user transmission according to an embodiment of the present invention.

FIG. 30 is a diagram illustrating a null data packet announcement (NDPA) frame according to an embodiment of the present invention.

FIG. 31 is a diagram illustrating a pre-procedure for the uplink multi-user transmission according to an embodiment of the present invention.

FIG. 32 is a block diagram illustrating a wireless apparatus according to an embodiment of the present invention.

### MODE FOR INVENTION

Hereinafter, a preferred embodiment of the present invention will be described by reference to the accompanying drawings. The description that will be described below with the accompanying drawings is to describe exemplary embodiments of the present invention, and is not intended to describe the only embodiment in which the present invention may be implemented. The description below includes particular details in order to provide perfect understanding of the present invention. However, it is understood that the present invention may be embodied without the particular details to those skilled in the art.

In some cases, in order to prevent the technical concept of the present invention from being unclear, structures or devices which are publicly known may be omitted, or may be depicted as a block diagram centering on the core functions of the structures or the devices.

Specific terminologies used in the description below may be provided to help the understanding of the present invention. And, the specific terminology may be modified into other forms within the scope of the technical concept of the present invention.

The following technologies may be used in a variety of wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and non-orthogonal multiple access (NOMA). CDMA may be implemented using a radio technology, such as universal terrestrial radio access (UTRA) or CDMA2000. TDMA may be implemented using a radio technology, such as global system for Mobile communications (GSM)/general packet radio service (GPRS)/enhanced data rates for GSM evolution (EDGE). OFDMA may be implemented using a radio technology, such as institute of electrical and electronics engineers (IEEE) 802.11 (Wi-Fi), IEEE 802.16 (WiMAX), IEEE 802.20, or evolved UTRA (E-UTRA). UTRA is part of a universal mobile telecommunications system (UMTS). 3rd generation partnership project (3GPP) long term evolution (LTE) is part of an evolved UMTS (E-UMTS) using evolved UMTS terrestrial radio access (E-UTRA), and it adopts OFDMA in downlink and adopts SC-FDMA in uplink. LTE-advanced (LTE-A) is the evolution of 3GPP LTE.

Embodiments of the present invention may be supported by the standard documents disclosed in at least one of IEEE 802, 3GPP, and 3GPP2, that is, radio access systems. That is, steps or portions that belong to the embodiments of the present invention and that are not described in order to clearly expose the technical spirit of the present invention may be supported by the documents. Furthermore, all terms disclosed in this document may be described by the standard documents.

In order to more clarify a description, IEEE 802.11 is chiefly described, but the technical characteristics of the present invention are not limited thereto.

General System

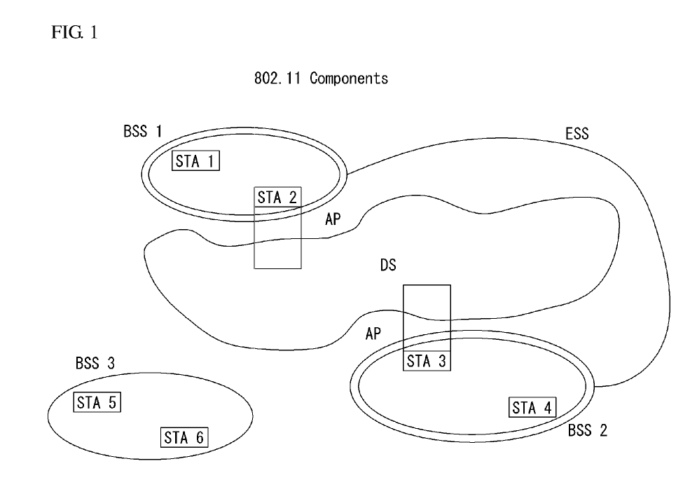

FIG. 1 is a diagram showing an example of an IEEE 802.11 system to which an embodiment of the present invention may be applied.

The IEEE 802.11 configuration may include a plurality of elements. There may be provided a wireless communication system supporting transparent station (STA) mobility for a higher layer through an interaction between the elements. A basic service set (BSS) may correspond to a basic configuration block in an IEEE 802.11 system.

FIG. 1 illustrates that three BSSs BSS 1 to BSS 3 are present and two STAs (e.g., an STA 1 and an STA 2 are included in the BSS 1, an STA 3 and an STA 4 are included in the BSS 2, and an STA 5 and an STA 6 are included in the BSS 3) are included as the members of each BSS.

In FIG. 1, an ellipse indicative of a BSS may be interpreted as being indicative of a coverage area in which STAs included in the corresponding BSS maintain communication. Such an area may be called a basic service area (BSA). When an STA moves outside the BSA, it is unable to directly communicate with other STAs within the corresponding BSA.

In the IEEE 802.11 system, the most basic type of a BSS is an independent a BSS (IBSS). For example, an IBSS may have a minimum form including only two STAs. Furthermore, the BSS 3 of FIG. 1 which is the simplest form and from which other elements have been omitted may correspond to a representative example of the IBSS. Such a configuration may be possible if STAs can directly communicate with each other. Furthermore, a LAN of such a form is not previously planned and configured, but may be configured when it is necessary. This may also be called an ad-hoc network.

When an STA is powered off or on or an STA enters into or exits from a BSS area, the membership of the STA in the BSS may be dynamically changed. In order to become a member of a BSS, an STA may join the BSS using a synchronization process. In order to access all of services in a BSS-based configuration, an STA needs to be associated with the BSS. Such association may be dynamically configured, and may include the use of a distribution system service (DSS).

In an 802.11 system, the distance of a direct STA-to-STA may be constrained by physical layer (PHY) performance. In any case, the limit of such a distance may be sufficient, but communication between STAs in a longer distance may be required, if necessary. In order to support extended coverage, a distribution system (DS) may be configured.

The DS means a configuration in which BSSs are interconnected. More specifically, a BSS may be present as an element of an extended form of a network including a plurality of BSSs instead of an independent BSS as in FIG. 1.

The DS is a logical concept and may be specified by the characteristics of a distribution system medium (DSM). In the IEEE 802.11 standard, a wireless medium (WM) and a distribution system medium (DSM) are logically divided. Each logical medium is used for a different purpose and used by a different element. In the definition of the IEEE 802.11 standard, such media are not limited to the same one and are also not limited to different ones. The flexibility of the configuration (i.e., a DS configuration or another network configuration) of an IEEE 802.11 system may be described in that a plurality of media is logically different as described above. That is, an IEEE 802.11 system configuration may be implemented in various ways, and a corresponding system configuration may be independently specified by the physical characteristics of each implementation example.

The DS can support a mobile device by providing the seamless integration of a plurality of BSSs and providing logical services required to handle an address to a destination.

An AP means an entity which enables access to a DS through a WM with respect to associated STAs and has the STA functionality. The movement of data between a BSS and the DS can be performed through an AP. For example, each of the STA 2 and the STA 3 of FIG. 1 has the functionality of an STA and provides a function which enables associated STAs (e.g., the STA 1 and the STA 4) to access the DS. Furthermore, all of APs basically correspond to an STA, and thus all of the APs are entities capable of being addressed. An address used by an AP for communication on a WM and an address used by an AP for communication on a DSM may not need to be necessarily the same.

Data transmitted from one of STAs, associated with an AP, to the STA address of the AP may be always received by an uncontrolled port and processed by an IEEE 802.1X port access entity. Furthermore, when a controlled port is authenticated, transmission data (or frame) may be delivered to a DS.

A wireless network having an arbitrary size and complexity may include a DS and BSSs. In an IEEE 802.11 system, a network of such a method is called an extended service set (ESS) network. The ESS may correspond to a set of BSSs connected to a single DS. However, the ESS does not include a DS. The ESS network is characterized in that it looks like an IBSS network in a logical link control (LLC) layer. STAs included in the ESS may communicate with each other. Mobile STAs may move from one BSS to the other BSS (within the same ESS) in a manner transparent to the LLC layer.

In an IEEE 802.11 system, the relative physical positions of BSSs in FIG. 1 are not assumed, and the following forms are all possible.

More specifically, BSSs may partially overlap, which is a form commonly used to provide consecutive coverage. Furthermore, BSSs may not be physically connected, and logically there is no limit to the distance between BSSs. Furthermore, BSSs may be placed in the same position physically and may be used to provide redundancy. Furthermore, one (or one or more) IBSS or ESS networks may be physically present in the same space as one or more ESS networks. This may correspond to an ESS network form if an ad-hoc network operates at the position in which an ESS network is present, if IEEE 802.11 networks that physically overlap are configured by different organizations, or if two or more different access and security policies are required at the same position.

In a WLAN system, an STA is an apparatus operating in accordance with the medium access control (MAC)/PHY regulations of IEEE 802.11. An STA may include an AP STA and a non-AP STA unless the functionality of the STA is not individually different from that of an AP. In this case, assuming that communication is performed between an STA and an AP, the STA may be interpreted as being a non-AP STA. In the example of FIG. 1, the STA 1, the STA 4, the STA 5, and the STA 6 correspond to non-AP STAs, and the STA 2 and the STA 3 correspond to AP STAs.

A non-AP STA corresponds to an apparatus directly handled by a user, such as a laptop computer or a mobile phone. In the following description, a non-AP STA may also be called a wireless device, a terminal, user equipment (UE), a mobile station (MS), a mobile terminal, a wireless terminal, a wireless transmit/receive unit (WTRU), a network interface device, a machine-type communication (MTC) device, a machine-to-machine (M2M) device or the like.

Furthermore, an AP is a concept corresponding to a base station (BS), a node-B, an evolved Node-B (eNB), a base transceiver system (BTS), a femto BS or the like in other wireless communication fields.

Hereinafter, in this specification, downlink (DL) means communication from an AP to a non-AP STA. Uplink (UL) means communication from a non-AP STA to an AP. In DL, a transmitter may be part of an AP, and a receiver may be part of a non-AP STA. In UL, a transmitter may be part of a non-AP STA, and a receiver may be part of an AP.

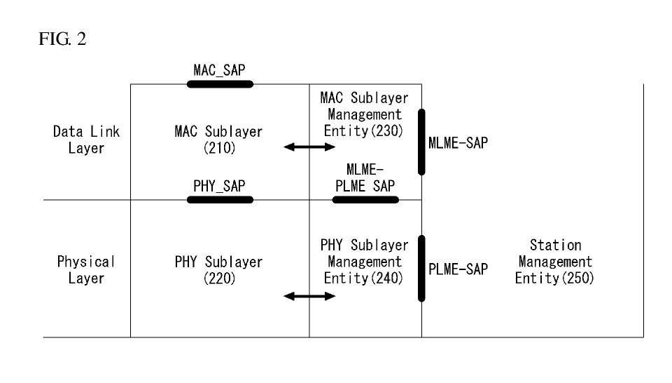

FIG. 2 is a diagram exemplifying a structure of layer architecture in IEEE 802.11 system to which the present invention may be applied.

Referring to FIG. 2, the layer architecture in the IEEE 802.11 system may include Medium Access Control (MAC) sublayer/layer and PHY sublayer/layer.

The PHY sublayer (220) may be divided into a Physical Layer Convergence Procedure (PLCP) entity and a Physical Medium Dependent (PMD) entity. In this case, the PLCP entity performs a role of connecting the MAC sublayer and a data frame, and the PMD entity performs a role of wirelessly transmitting and receiving data with two or more STAs.

Both of the MAC sublayer (210) and the PHY sublayer (220) may include management entities, and each of them may be referred to MAC Sublayer Management Entity (MLME, 230) and Physical Sublayer Management Entity (PLME, 240), respectively. These management entities (230, 240) provide a layer management service interface through an operation of layer management function. The MLME (230) may be connected to the PLME (240), and perform a management operation of MAC sublayer (21), and similarly, the PLME (240) may be connected to the MLME (230), and perform a management operation of PHY sublayer (220).

In order to provide an accurate MAC operation, a Station Management Entity (SME, 250) may be existed in each STA. The SME (250) is a management entity independent from each layer, and collects layer based state information from the MLME (230) and the PLME (240) or configures a specific parameter value of each layer. The SME (250) may perform such a function by substituting general system management entities, and may implement a standard management protocol.

The MLME (230), the PLME (240) and the SME (250) may interact in various methods based on a primitive. Particularly, XX-GET.request primitive is used for requesting a Management Information Base (MIB) attribute value. XX-GET.confirm primitive returns the corresponding MIB attribute value when the state of it is in ‘SUCCESS’, otherwise, returns a state field with an error mark. XX-SET.request primitive is used for requesting to configure a designated MIB attribute to a given value. When the MIB attribute signifies a specific operation, the request requests an execution of the specific operation. And, when a state of XX-SET.request primitive is in ‘SUCCESS’, this means that the designated MIB attribute is configured as the requested value. When the MIB attribute signifies a specific operation, the primitive is able to verify that the corresponding operation is performed.

The operation in each sublayer will be briefly described as follows.

MAC sublayer (210) generates one or more MAC Protocol Data Unit (MPDU) by attaching a MAC header and Frame Check Sequence (FCS) to a MAC Service Data Unit (MSDU) delivered from a higher layer (e.g., LLC layer) or a fragment of the MSDU. The generated MPDU is delivered to PHY sublayer (220).

When an aggregated MSDU (A-MSDU) scheme is used, a plurality of MSDUs may be merged into one A-MSDU. The MSDU merging operation may be performed in a MAC higher layer. The A-MSDU is delivered to PHY sublayer (220) as a single MPDU (i.e., not being fragmented).

PHY sublayer (220) generates a Physical Protocol Data Unit (PPDU) by attaching an additional field that includes required information to a Physical Service Data Unit (PSDU) received from MAC sublayer (210) by a physical layer transceiver. The PPDU is transmitted through a wireless medium.

Since the PSDU is a unit that PHY sublayer (220) receives from MAC sublayer (210) and MPDU is a unit that MAC sublayer (210) transmits to PHY sublayer (220), the PSDU is the same as the MPDU, substantially.

When an aggregated MPDU (A-MPDU) scheme is used, a plurality of MPDUs (in this case, each MPDU may carry the A-MPDU) may be merged into a single A-MPDU. The MPDU merging operation may be performed in a MAC lower layer. Various types of MPDU (e.g., QoS data, Acknowledge (ACK), block ACK, etc.) may be merged into the A-MPDU. PHY sublayer (220) receives the A-MPDU from MAC sublayer (210) as a single PSDU. That is, the PSDU includes a plurality of MPDUs. Accordingly, the A-MPDU is transmitted through a wireless medium within a single PPDU.

Physical Protocol Data Unit (PPDU) Format

A Physical Protocol Data Unit (PPDU) signifies a data block which is generated in physical layer. Hereinafter, the PPDU format will be described based on IEEE 802.11 WLAN system to which the present invention may be applied.

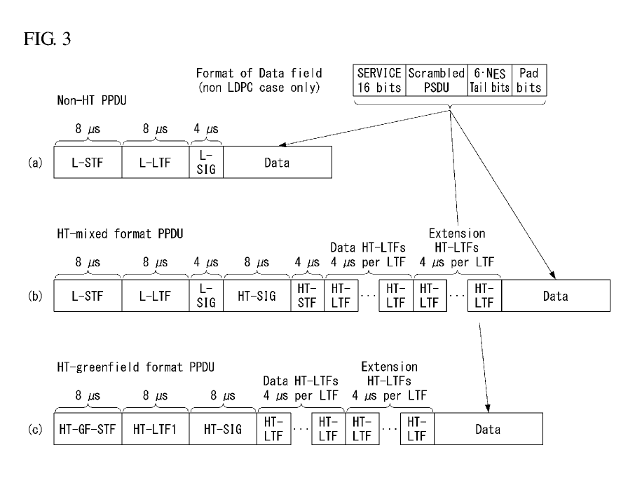

FIG. 3 exemplifies a non-HT format PPDU and an HT format PPDU of a wireless communication system to which the present invention may be applied.

FIG. 3(a) exemplifies the non-HT format for supporting IEEE 802.11a/g system. The non-HT PPDU may also be called a legacy PPDU.

Referring to FIG. 3(a), the non-HT format PPDU includes a legacy format preamble that includes a Legacy (or Non-HT) Short Training field (L-STF), a Legacy (or Non-HT) Long Training field (L-LTF) and a Legacy (or Non-HT) SIGNAL (L-SIG) field, and a data field.

The L-STF may include a short training orthogonal frequency division multiplexing (OFDM). The L-STF may be used for frame timing acquisition, Automatic Gain Control (AGC), diversity detection and coarse frequency/time synchronization.

The L-LTF may include a long training orthogonal frequency division multiplexing (OFDM) symbol. The L-LTF may be used for fine frequency/time synchronization and channel estimation.

The L-SIG field may be used for transmitting control information for demodulating and decoding a data field. The L-SIG field may include information on a data rate and a data length.

FIG. 3(b) exemplifies an HT-mixed format PPDU for supporting both IEEE 802.11n system and IEEE 802.11a/g system.

Referring to FIG. 3(b), the HT-mixed format PPDU includes an HT format preamble that includes a legacy format preamble including the L-STF, the L-LTF and the L-SIG field, an HT-Signal (HT-SIG) field, an HT Short Training field (HT-STF) and an HT Long Training field (HT-LTF), and a data field.

Since the L-STF, the L-LTF and the L-SIG field signify legacy fields for backward compatibility, the fields from the L-STF to the L-SIG field are identical to those of the non-HT format. The L-STA may interpret a data field through the L-STF, the L-LTF and the L-SIG field even though the L-STA receives a HT-mixed PPDU. However, the L-LTF may further include information for channel estimation such that an HT-STA receives the HT-mixed PPDU and demodulates the L-SIG field and the HT-SIG field.

The HT-STA may notice that the field behind the legacy field is the HT-mixed format PPDU using the HT-SIG field, and based on this, the HT-STA may decode the data field.

The HT-LTF field may be used for channel estimation for demodulating the data field. Since IEEE 802.11n standard supports Single-User Multi-Input and Multi-Output (SU-MIMO), a plurality of the HT-LTF fields may be included for the channel estimation with respect to each data field transmitted via a plurality of spatial streams.

The HT-LTF field may include a data HT-LTF used for channel estimation with respect to spatial stream and an extension HT-LTF additionally used for full channel sounding. Accordingly, the number of a plurality of HT-LTF may be equal to or more than the number of transmitted spatial stream.

In the HT-mixed format PPDU, the L-STF, the L-LTF and the L-SIG field are firstly transmitted such that an L-STA also receives and acquires data. Later, the HT-SIG field is transmitted for demodulating and decoding the data transmitted for the HT-STA.

Up to the HT-SIG field, fields are transmitted without performing beamforming such that the L-STA and the HT-STA receive the corresponding PPDU and acquire data, and wireless signal transmission is performed through precoding for the HT-STF, the HT-LTF and the data field, which are transmitted later. Herein, the plurality of HT-LTF and the data field are transmitted after transmitting the HT-STF such that the STA that receives data through precoding may consider the part in which power is varied by precoding.

FIG. 3(c) exemplifies an HT-greenfield (HT-GF) format PPDU for supporting IEEE 802.11n system only.

Referring to FIG. 3(c), the HT-GF format PPDU includes an HT-GF-STF, an HT-LTF1, an HT-SIG field, a plurality of HT-LTF2 and a data field.

The HT-GF-STF is used for frame time acquisition and AGC.

The HT-LTF1 is used for channel estimation.

The HT-SIG field is used for demodulating and decoding the data field.

The HT-LTF2 is used for channel estimation for demodulating the data field. Similarly, since the HT-STA requires channel estimation for each data field transmitted via a plurality of spatial streams due to the use of SU-MIMO, a plurality of HT-LTF2 may be included.

The plurality of HT-LTF2 may include a plurality of DATA HT-LTF and a plurality of extension HT-LTF, similar to the HT-LTF field of the HT-mixed PPDU.

In FIGS. 3(a) to 3(c), the data field is a payload, and the data field may include a SERVICE field, a scrambled PSDU field, Tail bits, and padding bits.

In order to effectively utilize radio channels, IEEE 802.11ac WLAN system supports a transmission of downlink Multi User Multiple Input Multiple Output (MU-MIMO) scheme in which a plurality of STAs access channel simultaneously. According to the MU-MIMO transmission scheme, an AP may transmit packets to one or more STAs that are paired by MIMO simultaneously.

A downlink multi-user (DL MU) transmission means a technique that an AP transmits a PPDU to a plurality of non-AP STAs through the same time resource through one or more antennas.

Hereinafter, the MU PPDU means a PPDU that transmits one or more PSDUs for one or more STAs using the MU-MIMO technique or the OFDMA technique. And the SU PPDU means a PPDU which is available to deliver only one PSDU or a PPDU that has a format in which the PSDU is not existed.

For the MU-MIMO transmission, the size of the control information transmitted to an STA may be relatively greater than that of the control information based on 802.11n. Examples of the control information additionally required for supporting the MU-MIMO may include information indicating the number of spatial stream received by each STA, the information related to modulating and coding the data transmitted to each STA, and the like.

Accordingly, when the MU-MIMO transmission is performed for providing data service to a plurality of STAs simultaneously, the size of transmitted control information may increase as the number of STAs that receive the control information.

As such, in order to effectively transmit the increasing size of the control information, a plurality of control information required for the MU-MIMO transmission may be transmitted by being classified into common control information commonly required for all STAs and dedicated control information individually required for a specific STA.

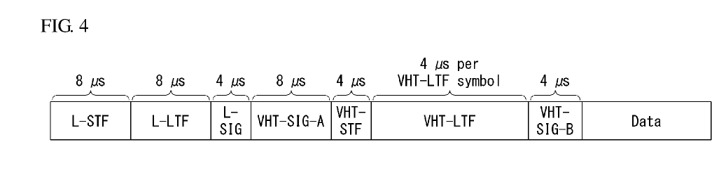

FIG. 4 exemplifies a VHT format PPDU of a wireless communication system to which the present invention may be applied.

Referring to FIG. 4, the VHT format PPDU includes a legacy format preamble that includes the L-STF, the L-LTF and the L-SIG field and a VHT format preamble that includes a VHT-Signal-A (VHT-SIG-A) field, a VHT Short Training field (VHT-STF), a VHT Long Training field (VHT-LTF) and a VHT-Signal-B (VHT-SIG-B) field and a data field.

Since the L-STF, the L-LTF and the L-SIG field signify legacy fields for backward compatibility, the fields from the L-STF to the L-SIG field are identical to those of the non-HT format. However, the L-LTF may further include information for channel estimation to be performed to demodulate the L-SIG field and the VHT-SIG-A field.

The L-STF, the L-LTF, the L-SIG field and the VHT-SIG-A field may be repeatedly transmitted in a unit of 20 MHz channel. For example, when a PPDU is transmitted through four 20 MHz channels (i.e., 80 MHz bandwidth), the L-STF, the L-LTF, the L-SIG field and the VHT-SIG-A field may be repeatedly transmitted in every 20 MHz channel.

The VHT-STA may be aware whether the PPDU is the VHT format PPDU using the VHT-SIG-A field which follows the legacy field, and based on this, the VHT-STA may decode the data field.

In the VHT format PPDU, the L-STF, the L-LTF and the L-SIG field are firstly transmitted such that an L-STA also receives and acquires data. Later, the VHT-SIG-A field is transmitted for demodulating and decoding the data transmitted for the VHT-STA.

The VHT-SIG-A field is a field for transmitting common control information between VHT STAs paired with an AP in MIMO scheme, and includes the control information for interpreting the received VHT format PPDU.

The VHT-SIG-A field may include a VHT-SIG-A1 field and a VHT-SIG-A2 field.

The VHT-SIG-A1 field may include channel bandwidth (BW) information to use, information on whether to apply Space Time Block Coding (STBC), Group Identifier (Group ID) information for indicating a group of STAs that are grouped in MU-MIMO scheme, information of the Number of space-time stream (NSTS) to use/Partial association Identifier (AID) and Transmit power save forbidden information. Herein, the Group ID may signify an identifier allocated to an STA group which is to be transmitted for supporting MU-MIMO transmission, and may represent whether the currently used MIMO transmission scheme is MU-MIMO or SU-MIMO.

Table 1 below exemplifies the VHT-SIG-A1 field.

TABLE 1

| Field | Bit | Description |
|---|---|---|
| BW | 2 | In the case of 20 MHz, set to ‘0’, |
| | | In the case of 40 MHz, set to ‘1’, |
| | | In the case of 80 MHz, set to ‘2’, |
| | | In the case of 160 MHz or 80 + 80 MHz, set to ‘3’. |
| Reserved | 1 | |
| STBC | 1 | In the case of VHT SU PPDU: |
| | | In the case that STBC is used, set to ‘1’, |
| | | Otherwise, set to ‘0’ |
| | | In the case of VHT MU PPDU: |
| | | Set to ‘0’ |
| Group ID | 6 | Indicate Group ID |
| | | ‘0’ or ‘63’ indicates VHT SU PPDU, otherwise indicates VHT |
| | | MU PPDU |
| NSTS/Partial AID | 12 | In the case of VHT MU PPDU, divided by 4 user position ‘p’ |
| | | each having 3 bits |
| | | In the case that space time stream is 0, set to ‘0’, |
| | | In the case that space time stream is 1, set to ‘1’, |
| | | In the case that space time stream is 2, set to ‘2’, |
| | | In the case that space time stream is 3, set to ‘3’, |
| | | In the case that space time stream is 4, set to ‘4’. |
| | | In the case of VHT SU PPDU, |
| | | Top 3 bits are set as follows. |
| | | In the case that space time stream is 1, set to ‘0’, |
| | | In the case that space time stream is 2, set to ‘1’, |
| | | In the case that space time stream is 3, set to ‘2’, |
| | | In the case that space time stream is 4, set to ‘3’, |
| | | In the case that space time stream is 5, set to ‘4’, |
| | | In the case that space time stream is 6, set to ‘5’, |
| | | In the case that space time stream is 7, set to ‘6’, |
| | | In the case that space time stream is 8, set to ‘7’, |
| | | Bottom 9 bits indicate Partial AID. |
| TXOP_PS_NOT_ALLOWED | 1 | When a VHT AP allows non-AP VHT STA shifted top a power |
| | | save mode for transmission opportunity (TXOP), set to ‘0’. |
| | | Otherwise, set to ‘1’. |
| | | In the case of a VHT PPDU transmitted by non-AP VHT STA, |
| | | set to ‘1’. |
| Reserved | 1 | |

The VHT-SIG-A2 field may include information on whether to use a short Guard Interval (GI), Forward Error Correction (FEC) information, information on Modulation and Coding Scheme (MCS) for a single user, information on types of channel coding for a plurality of users, beamforming related information, redundancy bits for Cyclic Redundancy Checking (CRC), a tail bit of convolutional decoder, and the like.

Table 2 below exemplifies the VHT-SIG-A2 field.

TABLE 2

| Field | Bit | Description |
|---|---|---|
| Short GI | 1 | In the case that short GI is not used in a data field, set to |
| | | ‘0’, |
| | | In the case that short GI is used in a data field, set to ‘1’. |
| Short GI | 1 | In the case that short GI is used and an additional symbol |
| disambiguation | | is required for a payload of PPDU, set to ‘1’, |
| | | In the case that an additional symbol is not required, set to |
| | | ‘0’. |
| SU/MU Coding | 1 | In the case of VHT SU PPDU: |
| | | In the case of BCC(binary convolutional code), set to ‘0’, |
| | | In the case of LDPC (low-density parity check), set to ‘1’. |
| | | In the case of VHT MU PPDU: |
| | | In the case that NSTS field of which user position is ‘0’ is |
| | | not ‘0’, indicates coding to use. |
| | | In the case of BCC, set to ‘0’, |
| | | In the case of LDPC, set to ‘1’. |
| | | In the case that NSTS field of which user position is ‘0’ is |
| | | ‘0’, set to ‘1’ as a reserved field. |
| LDPC Extra OFDM | 1 | In the case that an additional extra OFDM symbol is |
| Symbol | | required owing to LDPC PPDU encoding procedure (in the |
| | | case of SU PPDU) or PPDU encoding procedure of at least |
| | | one LDPC user (in the case of VHT MU PPDU), set to ‘1’. |
| | | Otherwise, set to ‘0’. |
| SU VHT MCS/MU | 4 | In the case of VHT SU PPDU: |
| Coding | | Represents VHT-MCS index. |
| | | In the case of VHT MU PPDU: |
| | | Indicates coding for user positions ‘1’ to ‘3’ in an order of |
| | | ascending order from top bit. |
| | | In the case that NSTS field of each user is not ‘1’, indicates |
| | | coding to use. |
| | | In the case of BCC, set to ‘0’, |
| | | In the case of LDPC, set to ‘1’. |
| | | In the case that NSTS field of each user is ‘0’, set to ‘1’ as a |
| | | reserved field. |
| Beamformed | 1 | In the case of VHT SU PPDU: |
| | | In the case that Beamforming steering matrix is applied to |
| | | SU transmission, set to ‘1’. |
| | | Otherwise, set to ‘0’ |
| | | In the case of VHT MU PPDU: |
| | | Set to ‘1’ as a reserved field. |
| Reserved | 1 | |
| CRC | 8 | Include CRC for detecting error of PPDU in receiver |
| Tail | 6 | Used for trellis end of convolutional decoder |
| | | Set to ‘0’. |

The VHT-STF is used for improving the performance of AGC estimation in MIMO transmission.

The VHT-LTF is used for a VHT-STA to estimate a MIMO channel. Since a VHT WLAN system support the MU-MIMO, the VHT-LTF may be setup as much as the number of spatial streams through which a PPDU is transmitted. Additionally, in the case that full channel sounding is supported, the number of VHT-LTFs may increase.

The VHT-SIG-B field includes dedicated control information required to acquire data for a plurality of VHT-STAs paired in MU-MIMO scheme by receiving a PPDU. Accordingly, only in the case that the common control information included in the VHT-SIG-A field indicates a MU-MIMO transmission by a PPDU which is currently received, a VHT-STA may be designed to decode the VHT-SIG-B field. On the contrary, in the case that the common control information indicates that a PPDU currently received is for a single VHT-STA (including SU-MIMO), an STA may be designed not to decode the VHT-SIG-B field.

The VHT-SIG-B field includes information on modulation, encoding and rate-matching of each of the VHT-STAs. A size of the VHT-SIG-B field may be different depending on types of MIMO transmission (MU-MIMO or SU-MIMO) and channel bandwidths which are used for PPDU transmissions.

In order to transmit PPDUs of the same size to STAs paired with an AP in a system that supports the MU-MIMO, information indicating a bit size of a data field that configures the PPDU and/or information indicating a bit stream size that configures a specific field may be included in the VHT-SIG-A field.

However, in order to efficiently use the PPDU format, the L-SIG field may be used. In order for the PPDUs of the same size to be transmitted to all STAs, a length field and a rate field transmitted with being included in the L-SIG field may be used for providing required information. In this case, since a MAC Protocol Data Unit (MPDU) and/or an Aggregate MAC Protocol Data Unit (A-MPDU) are configured based on bytes (or octet (oct)) of the MAC layer, an additional padding may be required in the physical layer.

The data field in FIG. 4 is a payload, and may include a SERVICE field, a scrambled PSDU, tail bits and padding bits.

As such, since several formats of PPDU are used in a mixed manner, an STA should be able to distinguish a format of received PPDU.

Herein, the meaning of distinguishing PPDU (or classifying the format of PPDU) may have various meanings. For example, the meaning of distinguishing PPDU may have a meaning of determining whether the received PPDU is a PPDU that is available to be decoded (or interpreted) by an STA. In addition, the meaning of distinguishing PPDU may have a meaning of determining whether the received PPDU is a PPDU that is available to be supported by an STA. Further, the meaning of distinguishing PPDU may be interpreted as a meaning of classifying what the information is that is transmitted through the received PPDU.

This will be described in more detail by reference to the drawing below.

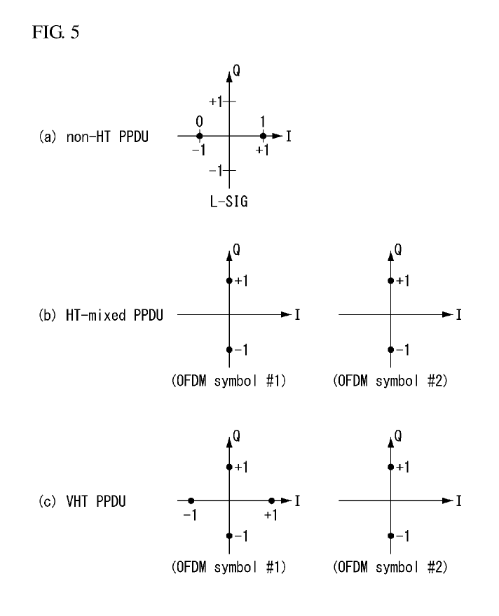

FIG. 5 is a diagram exemplifying a constellation for distinguishing a format of PPDU in a wireless communication system to which the present invention may be applied.

FIG. 5(a) exemplifies a constellation of an L-SIG field included in a non-HT format PPDU and FIG. 5(b) exemplifies a phase rotation for detecting an HT-mixed format PPDU. And FIG. 5(c) exemplifies a phase rotation for detecting a VHT format PPDU.

In order for an STA to distinguish the non-HT format PPDU, the HT-GF format PPDU, the HT-mixed format PPDU and the VHT format PPDU, a phase of constellation of the L-SIG field and the OFDM symbol transmitted after the L-SIG field are used. That is, the STA may classify a PPDU format based on the phase of constellation of the L-SIG field and the OFDM symbol transmitted after the L-SIG field.

Referring to FIG. 5(a), the OFDM symbol that configures the L-SIG field utilizes Binary Phase Shift Keying (BPSK).

First, in order to distinguish the HT-GF format PPDU, when an initial SIG field is detected in a received PPDU, an STA determines whether the SIG field is the L-SIG field. That is, the STA tries to decode based on the constellation example shown in FIG. 5(a). When the STA fail to decode, it may be determined that the corresponding PPDU is the HT-GF format PPDU.

Next, in order to classify the non-HT format PPDU, the HT-mixed format PPDU and the VHT format PPDU, the phase of constellation of the OFDM symbol transmitted after the L-SIG field may be used. That is, the modulation method of the OFDM symbol transmitted after the L-SIG field may be different, and the STA may classify the PPDU formats based on the modulation method for the field after the L-SIG field of the received PPDU.

Referring to FIG. 5(b), in order to distinguish the HT-mixed format PPDU, the phase of two OFDM symbols transmitted after the L-SIG field in the HT-mixed format PPDU may be used.

More particularly, the phases of both OFDM symbol #1 and OFDM symbol #2 that correspond to the HT-SIG field transmitted after the L-SIG field in the HT-mixed format PPDU rotate as much as 90 degrees in counter-clock wise direction. That is, the modulation method for OFDM symbol #1 and OFDM symbol #2 uses Quadrature Binary Phase Shift Keying (QBPSK). The QBPSK constellation may be a constellation of which phase rotates as much as 90 degrees in counter-clock wise direction with respect to the BPSK constellation.

An STA tries to decode OFDM symbol #1 and OFDM symbol #2 that correspond to the HT-SIG field transmitted after the L-SIG field of the received PPDU based on the constellation example shown in FIG. 5(b). When the STA is successful in decoding, the STA determines the corresponding PPDU to be the HT format PPDU.

Next, in order to distinguish the non-HT format PPDU and the VHT format PPDU, the phase of constellation of the OFDM symbol transmitted after the L-SIG field may be used.

Referring to FIG. 5(c), in order to distinguish the VHT format PPDU, the phases of two OFDM symbols transmitted after the L-SIG field in the VHT format PPDU may be used.

More particularly, the phase of OFDM symbol #1 that corresponds to the VHT-SIG-A field after the L-SIG field in the VHT format PPDU does not rotate, but the phase of OFDM symbol #2 rotates as much as 90 degrees in counter-clock wise direction. That is, the modulation method for OFDM symbol #1 uses the BPSK and the modulation method for OFDM symbol #2 uses the QBPSK.

An STA tries to decode OFDM symbol #1 and OFDM symbol #2 that correspond to the VHT-SIG field transmitted after the L-SIG field of the received PPDU based on the constellation example shown in FIG. 5(c). When the STA is successful in decoding, the STA may determine the corresponding PPDU to be the VHT format PPDU.

On the other hand, when the STA fails to decode, the STA may determine the corresponding PPDU to be the non-HT format PPDU.

MAC Frame Format

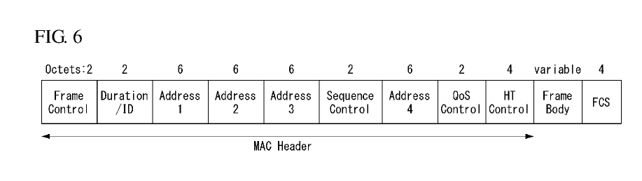

FIG. 6 exemplifies a MAC frame format in IEEE 802.11 system to which the present invention may be applied.

Referring to FIG. 6, a MAC frame (i.e., MPDU) includes a MAC Header, a Frame Body and a frame check sequence (FCS).

The MAC Header is defined by regions that include Frame Control field, Duration/ID field, Address 1 field, Address 2 field, Address 3 field, Sequence Control field, Address 4 field, QoS Control field and HT Control field.

The Frame Control field includes information on characteristics of the corresponding MAC frame. Detailed description for the Frame Control field will be described below.

The Duration/ID field may be implemented to have different values according to a type and a subtype of the corresponding MAC frame.

In the case that a type and a subtype of the corresponding MAC frame is a PS-Poll frame for the power save (PS) operation, the Duration/ID field may be configured to include an association identifier of the STA that transmits the frame. In other case, the Duration/ID field may be configured to have a specific duration value depending on the corresponding type and subtype of the MAC frame. In addition, in the case that the frame is an MPDU included in the aggregate-MPDU (A-MPDU) format, all of the Duration/ID fields included in the MAC header may be configured to have the same value.

Address 1 field to Address 4 field are used to indicate BSSID, source address (SA), destination address (DA), transmitting address (TA) representing an address of a transmission STA and a receiving address (RA) representing an address of a reception STA.

Meanwhile, the address field implemented as the TA field may be set to a bandwidth signaling TA value. In this case, the TA field may indicate that the corresponding MAC frame has additional information to the scrambling sequence. Although the bandwidth signaling TA may be represented as a MAC address of the STA that transmits the corresponding MAC frame, Individual/Group bit included in the MAC address may be set to a specific value (e.g., ‘1’).

The Sequence Control field is configured to include a sequence number and a fragment number. The sequence number may indicate the number of sequence allocated to the corresponding MAC frame. The fragment number may indicate the number of each fragment of the corresponding MAC frame.

The QoS Control field includes information related to QoS. The QoS control field may be included in the case that a QoS data frame is indicated in a Subtype subfield.

The HT Control filed includes control information related to HT and/or VHT transmission and reception techniques. The HT Control field is included in Control Wrapper frame. Further, the HT Control field is existed in the QoS data frame of which Order subfield value is 1, and existed in Management frame.

The Frame Body is defined as a MAC payload, and data to be transmitted in a higher layer is located therein. And the Frame body has a variable size. For example, a maximum size of MPDU may be 11454 octets, and a maximum size of PPDU may be 5.484 ms.

The FCS is defined as a MAC footer, and used for searching an error of the MAC frame.

First three fields (the Frame Control field, the Duration/ID field and the Address 1 field) and the last field (FCS field) configure a minimum frame format, and are existed in all frames. Other fields may be existed in a specific frame type.

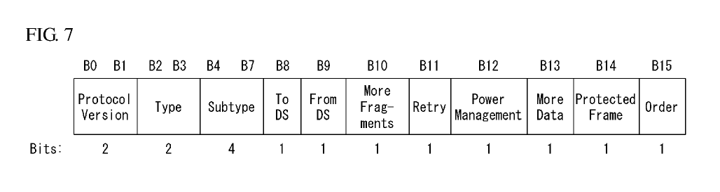

FIG. 7 is a diagram illustrating a frame control field in an MAC frame in the wireless communication system to which the present invention may be applied.

Referring to FIG. 7, the frame control field is comprised of a Protocol Version subfield, a Type sub field, a Subtype subfield, a To Ds subfield, a From DS subfield, a More Fragments subfield, a Retry subfield, a Power Management subfield, a More Data subfield, a Protected Frame subfield, and an Order subfield.

The Protocol Version subfield may indicate a version of a WLAN protocol applied to the corresponding MAC frame.

The Type subfield and the Subtype subfield may be set to indicate information identify a function of the corresponding MAC frame.

A type of the MAC frame may include three frame types of a management frame, a control frame, and a data frame.

In addition, each of the frame types may be divided into subtypes again.

For example, the control frames may include a request to send (RTS) frame, a clear-to-send (CTS) frame, an acknowledgment (ACK) frame, a PS-Poll frame, a contention free (CF)-End frame, a CF-End+CF-ACK frame, a block ACK request (BAR) frame, a block acknowledgement (BA) frame, a control wrapper (Control+HTcontrol) frame, null data packet announcement (NDPA), and a beamforming report poll frame.

The management frames may include a beacon frame, an announcement traffic indication message (ATIM) frame, a dissociation frame, an association request/response frame, a reassociation request/response frame, a probe request/response frame, an authentication frame, a deauthentication frame, an action frame, an action No ACK frame, and a timing advertisement frame.

The To DS subfield and the From DS subfield may include information required for interpreting an Address 1 field to an Address 4 field included in the corresponding MAC frame header. In the case of the Control frame, both the To DS subfield and the From DS subfield are set to ‘0’. In the case of the Management frame, both the To DS subfield and the From DS subfield may be sequentially set to ‘1’ and ‘0’ when the corresponding frame is a QoS management frame (QMF) and both the To DS subfield and the From DS subfield may be sequentially set to ‘0’ and ‘0’ when the corresponding frame is not the QMF.

The More Fragments subfield may indicate whether a fragment to be transmitted subsequently to the corresponding MAC frame exists. When another fragment of the MSDU or MMPDU exists, the More Fragments subfield may be set to ‘1’ and if not, the More Fragments subfield may be set to ‘0’.

The Retry subfield may indicate whether the corresponding MAC frame depends on retransmission of the previous MAC frame. In the case of retransmission of the previous MAC frame, the Retry subfield may be set to ‘1’ and if not, the Retry subfield may be set to ‘0’.

The Power Management subfield may indicate a power management mode of the STA. When a Power Management subfield value is ‘1’, the corresponding Power Management subfield value may indicate that the STA may be switched to a power save mode.

The More Data subfield may indicate whether the MAC frame to be additionally transmitted exists. When the MAC frame to be additionally transmitted exists, the More Data subfield may be set to ‘1’ and if not, the More Data subfield may be set to ‘0’.

The Protected Frame subfield may indicate whether a frame body field is encrypted. When the frame body field includes information processed by a cryptographic encapsulation algorithm, the Protected Frame subfield may be set to ‘1’ and if not, the Protected Frame subfield may be set to ‘0’.

The information included in the aforementioned respective fields may follow a definition of the IEEE 802.11 system. Further, the respective fields correspond to examples of the fields which may be included in the MAC frame and are not limited thereto. That is, each field may be substituted with another field or further include an additional field and all fields may not be requisitely included.

Medium Access Mechanism

In IEEE 802.11, communication is basically different from that of a wired channel environment because it is performed in a shared wireless medium.

In a wired channel environment, communication is possible based on carrier sense multiple access/collision detection (CSMA/CD). For example, when a signal is once transmitted by a transmission stage, it is transmitted up to a reception stage without experiencing great signal attenuation because there is no great change in a channel environment. In this case, when a collision between two or more signals is detected, detection is possible. The reason for this is that power detected by the reception stage becomes instantly higher than power transmitted by the transmission stage. In a radio channel environment, however, since various factors (e.g., signal attenuation is great depending on the distance or instant deep fading may be generated) affect a channel, a transmission stage is unable to accurately perform carrier sensing regarding whether a signal has been correctly transmitted by a reception stage or a collision has been generated.

Accordingly, in a WLAN system according to IEEE 802.11, a carrier sense multiple access with collision avoidance (CSMA/CA) mechanism has been introduced as the basic access mechanism of MAC. The CAMA/CA mechanism is also called a distributed coordination function (DCF) of IEEE 802.11 MAC, and basically adopts a “listen before talk” access mechanism. In accordance with such a type of access mechanism, an AP and/or an STA perform clear channel assessment (CCA) for sensing a radio channel or a medium for a specific time interval (e.g., a DCF inter-frame space (DIFS)) prior to transmission. If, as a result of the sensing, the medium is determined to be an idle state, the AP and/or the STA starts to transmit a frame through the corresponding medium. In contrast, if, as a result of the sensing, the medium is determined to be a busy state (or an occupied status), the AP and/or the STA do not start their transmission, may wait for a delay time (e.g., a random backoff period) for medium access in addition to the DIFS assuming that several STAs already wait for in order to use the corresponding medium, and may then attempt frame transmission.

Assuming that several STAs trying to transmit frames are present, they will wait for different times because the STAs stochastically have different backoff period values and will attempt frame transmission. In this case, a collision can be minimized by applying the random backoff period.

Furthermore, the IEEE 802.11 MAC protocol provides a hybrid coordination function (HCF). The HCF is based on a DCF and a point coordination function (PCF). The PCF is a polling-based synchronous access method, and refers to a method for periodically performing polling so that all of receiving APs and/or STAs can receive a data frame. Furthermore, the HCF has enhanced distributed channel access (EDCA) and HCF controlled channel access (HCCA). In EDCA, a provider performs an access method for providing a data frame to multiple users on a contention basis. In HCCA, a non-contention-based channel access method using a polling mechanism is used. Furthermore, the HCF includes a medium access mechanism for improving the quality of service (QoS) of a WLAN, and may transmit QoS data in both a contention period (CP) and a contention-free period (CFP).

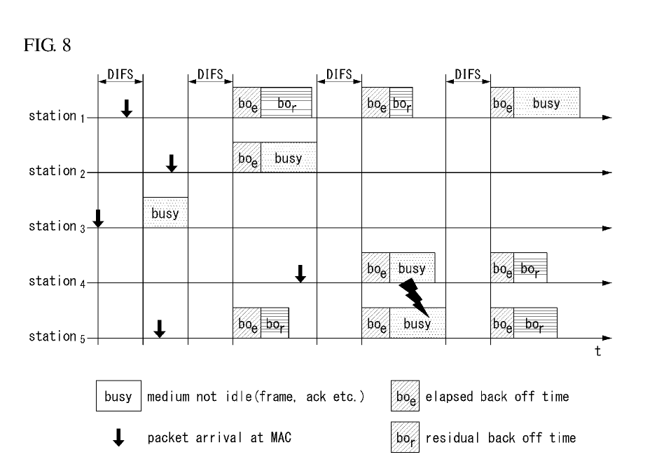

FIG. 8 is a diagram illustrating a random backoff period and a frame transmission procedure in a wireless communication system to which an embodiment of the present invention may be applied.

When a specific medium switches from an occupied (or busy) state to an idle state, several STAs may attempt to transmit data (or frames). In this case, as a scheme for minimizing a collision, each of the STAs may select a random backoff count, may wait for a slot time corresponding to the selected random backoff count, and may attempt transmission. The random backoff count has a pseudo-random integer value and may be determined as one of uniformly distributed values in 0 to a contention window (CW) range. In this case, the CW is a CW parameter value. In the CW parameter, CW_min is given as an initial value. If transmission fails (e.g., if ACK for a transmitted frame is not received), the CW_min may have a twice value. If the CW parameter becomes CW_max, it may maintain the CW_max value until data transmission is successful, and the data transmission may be attempted. If the data transmission is successful, the CW parameter is reset to a CW_min value. The CW, CW_min, and CW_max values may be set to 2̂n−1 (n=0, 1, 2, . . . ).

When a random backoff process starts, an STA counts down a backoff slot based on a determined backoff count value and continues to monitor a medium during the countdown. When the medium is monitored as a busy state, the STA stops the countdown and waits. When the medium becomes an idle state, the STA resumes the countdown.

In the example of FIG. 8, when a packet to be transmitted in the MAC of an STA 3 is reached, the STA 3 may check that a medium is an idle state by a DIFS and may immediately transmit a frame.

The remaining STAs monitor that the medium is the busy state and wait. In the meantime, data to be transmitted by each of an STA 1, an STA 2, and an STA 5 may be generated. When the medium is monitored as an idle state, each of the STAs waits for a DIFS and counts down a backoff slot based on each selected random backoff count value.

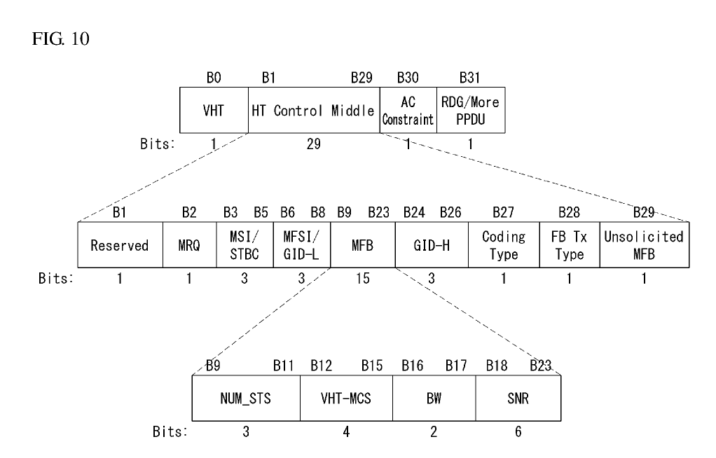

The example of FIG. 8 shows that the STA 2 has selected the smallest backoff count value and the STA 1 has selected the greatest backoff count value. That is, FIG. 10 illustrates that the remaining backoff time of the STA 5 is shorter than the remaining backoff time of the STA 1 at a point of time at which the STA 2 finishes a backoff count and starts frame transmission.

The STA 1 and the STA 5 stop countdown and wait while the STA 2 occupies the medium. When the occupation of the medium by the STA is finished and the medium becomes an idle state again, each of the STA 1 and the STA 5 waits for a DIFS and resumes the stopped backoff count. That is, each of the STA 1 and the STA 5 may start frame transmission after counting down the remaining backoff slot corresponding to the remaining backoff time. The STA 5 starts frame transmission because the STA 5 has a shorter remaining backoff time than the STA 1.

While the STA 2 occupies the medium, data to be transmitted by an STA 4 may be generated. In this case, from a standpoint of the STA 4, when the medium becomes an idle state, the STA 4 waits for a DIFS and counts down a backoff slot corresponding to its selected random backoff count value.

FIG. 8 shows an example in which the remaining backoff time of the STA 5 coincides with the random backoff count value of the STA 4. In this case, a collision may be generated between the STA 4 and the STA 5. When a collision is generated, both the STA 4 and the STA 5 do not receive ACK, so data transmission fails. In this case, each of the STA 4 and the STA 5 doubles its CW value, select a random backoff count value, and counts down a backoff slot.

The STA 1 waits while the medium is the busy state due to the transmission of the STA 4 and the STA 5. When the medium becomes an idle state, the STA 1 may wait for a DIFS and start frame transmission after the remaining backoff time elapses.

The CSMA/CA mechanism includes virtual carrier sensing in addition to physical carrier sensing in which an AP and/or an STA directly sense a medium.

Virtual carrier sensing is for supplementing a problem which may be generated in terms of medium access, such as a hidden node problem. For the virtual carrier sensing, the MAC of a WLAN system uses a network allocation vector (NAV). The NAV is a value indicated by an AP and/or an STA which now uses a medium or has the right to use the medium in order to notify another AP and/or STA of the remaining time until the medium becomes an available state. Accordingly, a value set as the NAV corresponds to the period in which a medium is reserved to be used by an AP and/or an STA that transmit corresponding frames.

An AP and/or an STA may perform a procedure for exchanging a request to send (RTS) frame and a clear to send (CTS) frame in order to provide notification that they will access a medium. The RTS frame and the CTS frame include information indicating a temporal section in which a wireless medium required to transmit/receive an ACK frame has been reserved to be accessed if substantial data frame transmission and an acknowledgement response (ACK) are supported. Another STA which has received an RTS frame from an AP and/or an STA attempting to send a frame or which has received a CTS frame transmitted by an STA to which a frame will be transmitted may be configured to not access a medium during a temporal section indicated by information included in the RTS/CTS frame. This may be implemented by setting the NAV during a time interval.

Interframe Space (IFS)

A time interval between frames is defined as an interframe space (IFS). An STA may determine whether a channel is used during an IFS time interval through carrier sensing. In an 802.11 WLAN system, a plurality of IFSs is defined in order to provide a priority level by which a wireless medium is occupied.

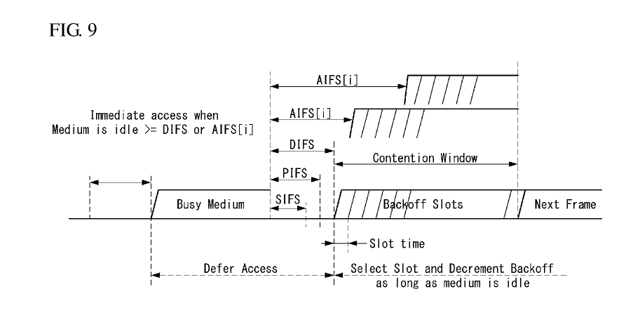

FIG. 9 is a diagram illustrating an IFS relation in a wireless communication system to which an embodiment of the present invention may be applied.

All of pieces of timing may be determined with reference to physical layer interface primitives, that is, a PHY-TXEND.confirm primitive, a PHYTXSTART.confirm primitive, a PHY-RXSTART.indication primitive, and a PHY-RXEND.indication primitive.

An interframe space (IFS) depending on an IFS type is as follows.

A reduced interframe space (IFS) (RIFS)

A short interframe space (IFS) (SIFS)

A PCF interframe space (IFS) (PIFS)

A DCF interframe space (IFS) (DIFS)

An arbitration interframe space (IFS) (AIFS)

An extended interframe space (IFS) (EIFS)

Different IFSs are determined based on attributes specified by a physical layer regardless of the bit rate of an STA. IFS timing is defined as a time gap on a medium. IFS timing other than an AIFS is fixed for each physical layer.

The SIFS is used to transmits a PPDU including an ACK frame, a CTS frame, a block ACK request (BlockAckReq) frame, or a block ACK (BlockAck) frame, that is, an instant response to an A-MPDU, the second or consecutive MPDU of a fragment burst, and a response from an STA with respect to polling according to a PCE The SIFS has the highest priority. Furthermore, the SIFS may be used for the point coordinator of frames regardless of the type of frame during a non-contention period (CFP) time. The SIFS indicates the time prior to the start of the first symbol of the preamble of a next frame which is subsequent to the end of the last symbol of a previous frame or from signal extension (if present).

SIFS timing is achieved when the transmission of consecutive frames is started in a Tx SIFS slot boundary.

The SIFS is the shortest in IFS between transmissions from different STAs. The SIFS may be used if an STA occupying a medium needs to maintain the occupation of the medium during the period in which the frame exchange sequence is performed.

Other STAs required to wait so that a medium becomes an idle state for a longer gap can be prevented from attempting to use the medium because the smallest gap between transmissions within a frame exchange sequence is used. Accordingly, priority may be assigned in completing a frame exchange sequence that is in progress.

The PIFS is used to obtain priority in accessing a medium.

The PIFS may be used in the following cases.

An STA operating under a PCF

An STA sending a channel switch announcement frame

An STA sending a traffic indication map (TIM) frame

A hybrid coordinator (HC) starting a CFP or transmission opportunity (TXOP)

An HC or non-AP QoS STA, that is, a TXOP holder polled for recovering from the absence of expected reception within a controlled access phase (CAP)

An HT STA using dual CTS protection before sending CTS2

A TXOP holder for continuous transmission after a transmission failure

A reverse direction (RD) initiator for continuous transmission using error recovery

An HT AP during a PSMP sequence in which a power save multi-poll (PSMP) recovery frame is transmitted

An HT AT performing CCA within a secondary channel before sending a 40 MHz mask PPDU using EDCA channel access

In the illustrated examples, an STA using the PIFS starts transmission after a carrier sense (CS) mechanism for determining that a medium is an idle state in a Tx PIFS slot boundary other than the case where CCA is performed in a secondary channel

The DIFS may be used by an STA which operates to send a data frame (MPDU) and a MAC management protocol data unit management (MMPDU) frame under the DCF. An STA using the DCF may transmit data in a TxDIFS slot boundary if a medium is determined to be an idle state through a carrier sense (CS) mechanism after an accurately received frame and a backoff time expire. In this case, the accurately received frame means a frame indicating that the PHY-RXEND.indication primitive does not indicate an error and an FCS indicates that the frame is not an error (i.e., error free).

An SIFS time (“aSIFSTime”) and a slot time (“aSlotTime”) may be determined for each physical layer. The SIFS time has a fixed value, but the slot time may be dynamically changed depending on a change in the wireless delay time “aAirPropagationTime.”

The “aSIFSTime” is defined as in Equations 1 and 2 below.

aSIFSTime(16 μs)=aRxRFDelay(0.5)+aRxPLCPDelay(12.5)+aMACProcessingDelay(1 or <2)+aRxTxTurnaroundTime(<2) [Equation 1]

aRxTxTurnaroundTime=aTxPLCPDelay(1)+aRxTxSwitchTime(0.25)+aTxRampOnTime(0.25)+aTxRFDelay(0.5) [Equation 2]

The “aSlotTime” is defined as in Equation 3 below.

aSlotTime=aCCATime(<4)+aRxTxTurnaroundTime(<2)+aAirPropagationTime(<1)+aMACProcessingDelay(<2) [Equation 3]

In Equation 3, a default physical layer parameter is based on “aMACProcessingDelay” having a value which is equal to or smaller than 1 μs. A radio wave is spread 300 m/μs in the free space. For example, 3 μs may be the upper limit of a BSS maximum one-way distance ˜450 m (a round trip is ˜900 m).

The PIFS and the SIFS are defined as in Equations 4 and 5, respectively.

PIFS(16 μs)=aSIFSTime+aSlotTime [Equation 4]

DIFS(34 μs)=aSIFSTime+2*aSlotTime [Equation 4]

In Equations 1 to 5, the numerical value within the parenthesis illustrates a common value, but the value may be different for each STA or for the position of each STA.

The aforementioned SIFS, PIFS, and DIFS are measured based on an MAC slot boundary (e.g., a Tx SIFS, a Tx PIFS, and a TxDIFS) different from a medium.

The MAC slot boundaries of the SIFS, the PIFS, and the DIFS are defined as in Equations 6 to 8, respectively.

TxSIFS=SIFS−aRxTxTurnaroundTime [Equation 6]

TxPIFS=TxSIFS+aSlotTime [Equation 7]

TxDIFS=TxSIFS+2*aSlotTIme [Equation 8]

Channel State Information Feedback Method

An SU-MIMO technology in which a beamformer communicates by allocating all antennas to a beamformee increases a channel capacity through diversity gain and stream multiple transmission using a time and a space. The SU-MIMO technology may contribute to performance enhancement of a physical layer by extending a spatial degree of freedom by increases the number of antennas as compared with a case where an MIMO technology is not applied.

Further, an MU-MIMO technology in which the beamformer allocates the antennas to a plurality of beamformees may enhance the performance of an MIMO antenna by increasing transmission rate per beamformee or reliability of the channel through a link layer protocol for multiple access of the plurality of beamformees accessing the beamformer.

In an MIMO environment, since how accurately the beamformer knows the channel information may exert a large influence on the performance, a feedback procedure for acquiring the channel is required.

As the feedback procedure for acquiring the channel information, two modes may be largely supported. One is a mode using the control frame and the other one is mode using a channel sounding procedure not including the data field. Sounding means using a corresponding training field in order to measure the channel for a purpose other than data demodulation of the PPDU including the training field.

Hereinafter, a channel information feedback method using the control frame and a channel information feedback method using a null data packet (NDP) will be described in more detail.

1) Feedback Method Using Control Frame

In the MIMO Environment, the Beamformer May Indicate Feedback of the channel state information through the HT control field included in the MAC header or report the channel state information through the HT control field included in the MAC frame header. The HT control field may be included in a control wrapper frame, a QoS Data frame in which the Order subfield of the MAC header is set to 1, or a management frame.

FIG. 10 illustrates a VHT format of an HT control field in the wireless communication system to which the present invention may be applied.

Referring to FIG. 10, the HT Control field may be comprised of a VHT subfield, an HT Control Middle subfield, an AC constraint subfield, and a Reverse Direction Grant (RDG)/More PPDU subfield.

The VHT subfield indicates whether the HT Control field has a format of the HT Control field for the VHT or whether the HT Control field has the format of the HT Control field for the HT. In FIG. 10, the HT Control field for the VHT is assumed and described. The HT Control field for the VHT may be referred to as a VHT Control field.

The HT Control Middle subfield may be implemented to have another format according to the indication of the VHT subfield. More detailed description of the HT Control Middle subfield will be made below.

The AC Constraint subfield indicates whether a mapped access category (AC) of a reverse direction (RD) data frame is limited to a single AC.

The RDG/More PPDU subfield may be differently interpreted according to whether the corresponding field is transmitted by an RD initiator or RD responder.

In the case where the corresponding field is transmitted by the RD initiator, when the RDG exists, the RDG/More PPDU field is set to ‘1’ and when the RDG does not exist, the RDG/More PPDU field is set to ‘0’. In the case where the corresponding field is transmitted by the RD responder, when the PPDU including the corresponding subfield is a last frame transmitted by the RD responder, the RDG/More PPDU field is set to ‘1’ and when another PPDU is transmitted, the RDG/More PPDU field is set to ‘0’.

The HT Control Middle subfield may be comprised of a reserved bit, a Modulation and Coding Scheme (MCS) feedback request (MRQ) subfield, an MRQ sequence identifier (MSI)/space-time block coding (STBC) subfield, a MCS feedback sequence identifier (MFSI)/Least Significant Bit (LSB) of Group ID (GID-L) subfield, an MCS feedback (MFB) subfield, a Most Significant Bit (MSB) of Group ID (GID-H) subfield, a coding type subfield, a feedback transmission type (FB Tx type) subfield, and an unsolicited MFB subfield.

Table 3 shows description of each subfield included in the HT Control Middle subfield of the VHT format.

TABLE 3

| Subfield | Meaning | Definition |
|---|---|---|
| MRQ | MCS request | MRQ is set to ‘1’ when MCS feedback (unsolicited |
| | | MFB) is requested |
| | | If not, MRQ is set to ‘0’ |
| MSI | MRQ sequence | When the unsolicited MFB subfield is ‘0’ and the |
| | identifier | MRQ subfield is set to ‘1’, the MSI subfield includes |
| | | a sequence number in the range of 0 to 6 to identify a |
| | | specific request |
| | | When the unsolicited MFB subfield is ‘1’, the MSI |
| | | subfield includes a compressed MSI subfield (2 bits) |
| | | and an STBC indication subfield (1 bit) |
| MFSI/GID-L | MFB sequence | When the unsolicited MFB subfield is set to ‘0’, the |
| | identifier/LSB of | MFSI/GID-L subfield includes a reception value of |
| | Group ID | the MSI included in the frame associated with the |
| | | MFB information |
| | | When the unsolicited MFB subfield is set to ‘1’ and |
| | | the MFB is estimated from the MU PPDU, the |
| | | MFSI/GID-L subfield includes LSB 3 bits of the |
| | | group ID of the estimated PPDU |
| MFB | VHT N_STS, | The MFB subfield includes the recommended MFB. |
| | MCS, BW, SNR | VHT-MCS = 15 and NUM_STS = 7 indicates there is no |
| | feedback | feedback |
| GID-H | MSB of Group ID | When the unsolicited MFB subfield is set to ‘1’ and |
| | | the MFB is estimated from the VHT MU PPDU, the |
| | | GID-H subfield includes MSB 3 bits of the group ID |
| | | of the estimated PPDU of the solicited MFB |
| | | The MFB is estimated from the SU PPDU and all of |
| | | the GID-H subfields are set to 1 |
| Coding Type | Coding type of | When the unsolicited MFB subfield is set to ‘1’, the |
| | MFB response | coding type subfield includes a coding type (binary |
| | | convolutional code (BCC)) is 0 and a low-density |
| | | parity check (LDPC) is 1) of a frame in which the |
| | | solicited MFB is estimated |
| FB Tx Type | Transmission type | When the unsolicited MFB subfield is set to ‘1’ and |
| | of MFB response | the MFB is estimated from an unbeamformed VHT |
| | | PPDU, the FB Tx Type subfield is set to ‘0’ |
| | | When the unsolicited MFB subfield is set to ‘1’ and |
| | | the MFB is estimated from the unbeamformed VHT |
| | | PPDU, the FB Tx Type subfield is set to ‘1’ |
| Unsolicited | Unsolicited MCS | When the MFB is a response to the MRQ, the |
| MFB | feedback | unsolicited MFB is set to ‘1’ |
| | indicator | When the MFB is not the response to the MRQ, the |
| | | unsolicited MFB is set to ‘0’ |

In addition, the MFB subfield may include a Number of space time streams (NUM_STS) subfield, a VHT-MCS subfield, a bandwidth (BW) subfield, and a signal to noise ratio (SNR) subfield.

The NUM_STS subfield indicates the number of recommended spatial streams. The VHT-MCS subfield indicates a recommended MCS. The BW subfield indicates bandwidth information associated with the recommended MCS. The SNR subfield indicates an average SNR value on a data subcarrier and the spatial stream.

The information included in the aforementioned respective fields may follow the definition of the IEEE 802.11 system. Further, the respective fields correspond to examples of the fields which may be included in the MAC frame and are not limited thereto. That is, each field may be substituted with another field or further include an additional field and all fields may not be requisitely included.

2) Feedback Method Using Channel Sounding

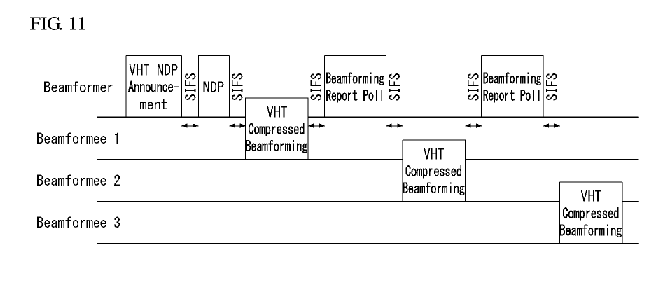

FIG. 11 is a diagram for conceptually describing a channel sounding method in the wireless communication system to which the present invention can be applied.

In FIG. 11, a method that feeds back the channel state information between the beamformer (for example, AP) and the beamformee (for example, non-AP STA) based on a sounding protocol is illustrated. The sounding protocol may mean a procedure that feeds back information on the channel state information.

A channel state information sounding method between the beamformer and the beamformee based on the sounding protocol may be performed by steps given below.

The beamformer transmits a VHT Null Data Packet Announcement (VHT NDPA) frame announcing sounding transmission for feedback of the beamformee.

The VHT NDPA frame means the control frame used to announce that the channel sounding is initiated and the null data packet (NDP) is transmitted. In other words, the VHT NDPA frame is transmitted before transmitting the NDP, and as a result, the beamformee may prepare for feeding back the channel state information before receiving the NDP frame.

The VHT NDPA frame may include association identifier (AID) information, feedback type information, and the like of the beamformee that will transmit the NDP. More detailed description of the VHT NDPA frame will be made below.

In the case where data is transmitted by using the MU-MIMO and in the case where the data is transmitted by using the SU-MIMO, the VHT NDPA frame may be transmitted by different transmission methods. For example, when the channel sounding for the MU-MIMO is performed, the VHT NDPA frame is transmitted by a broadcast method, but when the channel sounding for the SU-MIMO is performed, the VHT NDPA frame may be transmitted to one target STA by a unicast method.

(2) The beamformer transmits the VHT NDPA frame and thereafter, transmits the NDP after an SIFS time. The NDP has a VHT PPDU structure except for the data field.

The beamformees that receive the VHT NDPA frame may verify an AID12 subfield value included in the STA information field and verify the beamformees as sounding target STAs.

Further, the beamformees may know a feedback order through the order of the STA Info field included in the NDPA. In FIG. 11, a case where the feedback order is the order of beamformee 1, beamformee 2, and beamformee 3 is illustrated.

(3) Beamformee 1 acquires the downlink channel state information based on the training field included in the NDP to generate feedback information to be transmitted to the beamformer.

Beamformee 1 receives the NDP frame and thereafter, transmits a VHT compressed beamforming frame including the feedback information to the beamformer after the SIFS.

The VHT compressed beamforming frame may include an SNR value for the space-time stream, information on a compressed beamforming feedback matrix for a subcarrier, and the like. More detailed description of the Compressed Beamforming frame will be made below.

(4) The beamformer receives the VHT Compressed Beamforming frame beamformee 1 and thereafter, transmits the beamforming report poll frame to beamformee 2 in order to the channel information from beamformee 2 after the SIFS.

The beamforming report poll frame is a frame that performs the same role as the NDP frame and beamformee 2 may measure the channel state based on the transmitted beamforming report poll frame.

More detailed description of the beamforming report poll frame will be made below.

(5) Beamformee 2 that receives the beamforming report poll frame transmits the VHT compressed beamforming frame including the feedback information to the beamformer after the SIFS.

(6) The beamformer receives the VHT Compressed Beamforming frame beamformee 2 and thereafter, transmits the beamforming report poll frame to beamformee 3 in order to the channel information from beamformee 3 after the SIFS.

(7) Beamformee 3 that receives the beamforming report poll frame transmits the VHT compressed beamforming frame including the feedback information to the beamformer after the SIFS.

Hereinafter, the frame used in the aforementioned channel sounding procedure will be described.

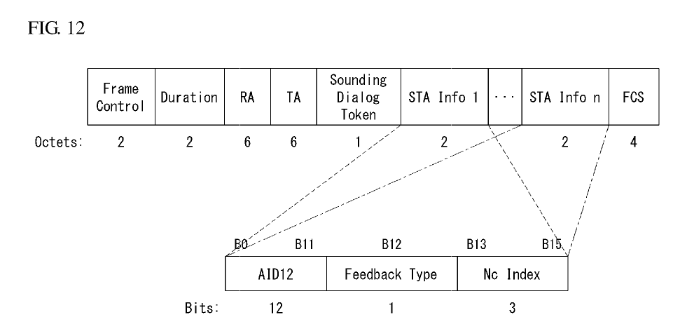

FIG. 12 is a diagram illustrating a VHT NDPA frame in the wireless communication system to which the present invention may be applied.

Referring to FIG. 12, the VHT NDPA frame may be comprised of a frame control field, a duration field, a receiving address (RA) field, a transmitting address (TA) field, a sounding dialog token field, an STA information 1 (STA Info 1) field to an STA information n (STA Info n) field, and an FCS.

The RA field value represents a receiver address or STA address that receives the VHT NDPA frame.

When the VHT NDPA frame includes one STA Info field, the RA field value has an address of the STA identified by the AID in the STA Info field. For example, when the VHT NDPA frame is transmitted to one target STA for SU-MIMO channel sounding, the AP transmits the VHT NDPA frame to the STA by unicast.

On the contrary, when the VHT NDPA frame includes one or more STA Info fields, the RA field value has a broadcast address. For example, when the VHT NDPA frame is transmitted to one or more target STAs for MU-MIMO channel sounding, the AP broadcasts the VHT NDPA frame.

The TA field value represents a bandwidth for signaling a transmitter address to transmit the NDPA frame or an address of the STA which transmits the VHT NDPA frame, or the TA.

The Sounding Dialog Token field may be referred to as a sounding sequence field. A Sounding Dialog Token Number subfield in the Sounding Dialog Token field includes a value selected by the beamformer in order to identify the VHT NDPA frame.

The VHT NDPA frame includes at least one STA Info field. That is, the VHT NDPA frame includes an STA Info field including information on a sounding target STA. One STA Info field may be included in each sounding target STA.

Each STA Info field may be constituted by an AID12 subfield, a Feedback Type subfield, and an Nc Index subfield.

Table 4 shows the subfield of the STA Info field included in the VHT NDPA frame.

TABLE 4

| Subfield | Description |
|---|---|
| AID12 | Includes the AID of the STA which becomes the sounding |
| | feedback target |
| | When the target STA is the AP, a mesh STA, or the STA |
| | which is an IBSS member, the AID12 subfield value |
| | is set to ‘0’ |
| Feedback | Indicates the feedback request type for the sounding |
| | target STA |
| Type | In the case of the SU-MIMO, ‘0’ |
| | In the case of the MU-MIMO, ‘1’ |
| Nc Index | When the Feedback Type subfield indicates the MU-MIMO, |
| | Nc Index indicates a value acquired by subtracting 1 from |
| | the number (Nc) of columns of the compressed |
| | beamforming feedback matrix |
| | In the case of Nc = 1, ‘0’, |
| | In the case of Nc = 2, ‘1’, |
| | . . . |
| | In the case of Nc = 8, ‘7’ |
| | In the case of the SU-MIMO, the Nc Index is set as a |
| | reserved subfield |

The information included in the aforementioned respective fields may follow the definition of the IEEE 802.11 system. Further, the respective fields correspond to examples of the fields which may be included in the MAC frame and substituted with another field or an additional field may be further included.

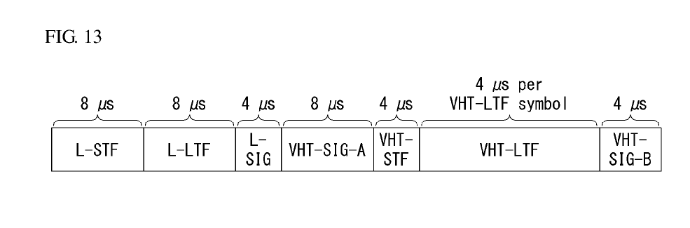

FIG. 13 is a diagram illustrating an NDP PPDU in the wireless communication system to which the present invention may be applied.

Referring to FIG. 13, the NDP may have a format in which the data field is omitted from the VHT PPDU format. The NDP is precoded based on a specific precoding matrix to be transmitted to the sounding target STA.

In the L-SIG field of the NDP, a length field indicating the length of the PSDU included in the data field is set to ‘0’.

A Group ID field indicating whether a transmission technique used for transmitting the NDP in the VHT-SIG-A field of the NDP is the MU-MIMO or the SU-MIMO is set to a value indicating the SU-MIMO transmission.

A data bit of the VHT-SIG-B field of the NDP is set to a bit pattern fixed for each bandwidth.

When the sounding target STA receives the NDP, the sounding target STA estimates the channel and acquires the channel state information based on the VHT-LTF field of the NDP.

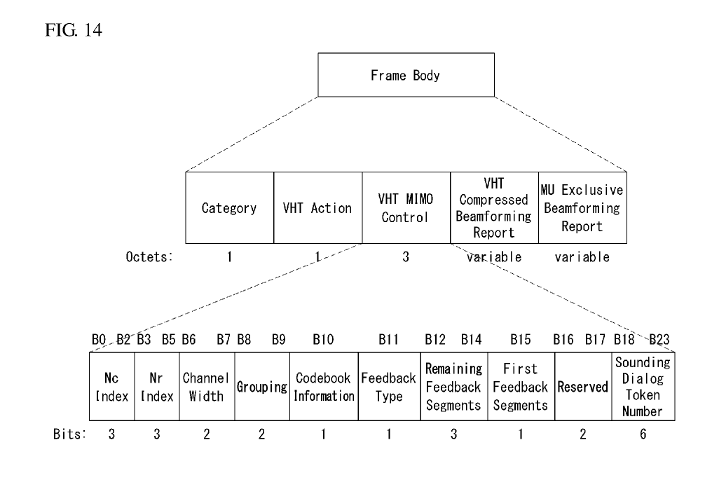

FIG. 14 is a diagram illustrating a VHT compressed beamforming frame format in the wireless communication system to which the present invention may be applied.

Referring to FIG. 14, the VHT compressed beamforming frame as a VHT action frame for supporting the VHT function includes the Action field in the frame body. The Action field provides a mechanism for specifying management operations included in and extended to the frame body of the MAC frame.

The Action field is comprised of a Category field, a VHT Action field, a VHT MIMO Control field, a VHT Compressed Beamforming Report field, and an MU Exclusive Beamforming Report field.

The Category field is set to a value indicating a VHT category (that is, VHT Action frame) and the VHT Action field is set to a value indicating the VHT Compressed Beamforming frame.

The VHT MIMO Control field is used for feeding back control information associated with beamforming feedback. The VHT MIMO Control field may always exist in the VHT Compressed Beamforming frame.

The VHT Compressed Beamforming Report field is used for feeding back information on the beamforming matrix including the SNR information for the space-time stream used for transmitting the data.

The MU Exclusive Beamforming Report field is used for feeding back the SNR information for a spatial stream when the MU-MIMO transmission is performed.

Whether the VHT Compressed Beamforming Report field and the MU Exclusive Beamforming Report field exist and contents of the VHT Compressed Beamforming Report field and the MU Exclusive Beamforming Report field may be determined according to values of a Feedback Type subfield, a Remaining Feedback Segments subfield, and a First Feedback Segment subfield of the VHT MIMO Control field.

Hereinafter, the VHT MIMO Control field, the VHT Compressed Beamforming Report field, and the MU Exclusive Beamforming Report field will be described in more detail.

1) The VHT MIMO Control field is comprised of an Nc Index subfield, an Nr Index subfield, a Channel Width subfield, a Grouping subfield, a Codebook Information subfield, a Feedback Type subfield, a Remaining Feedback Segments subfield, a First Feedback Segment subfield, a reserved subfield, and a Sounding Dialog Token Number subfield.

Table 5 shows the subfield of the VHT MIMO Control field.

TABLE 5

| | The | |
|---|---|---|
| | number | |
| Subfield | of bits | Description |
| Nc Index | 3 | Nc Index indicates a value acquired by subtracting 1 from |
| | | the number (Nc) of columns of the compressed |
| | | beamforming feedback matrix |
| | | In the case of Nc = 1, ‘0’, |
| | | In the case of Nc = 2, ‘1’, |
| | | . . . |
| | | In the case of Nc = 8, ‘7’ |
| Nr Index | 3 | Nr Index indicates a value acquired by subtracting 1 from |
| | | the number (Nr) of rows of the compressed beamforming |
| | | feedback matrix |
| | | In the case of Nr = 1, ‘0’, |
| | | In the case of Nr = 2, ‘1’, |
| | | . . . |
| | | In the case of Nr = 8, ‘7’ |
| Channel Width | 2 | Indicates the bandwidth of the channel measured in order |
| | | to generate the compressed beamforming feedback matrix |
| | | In the case of 20 MHz, ‘0’, |
| | | In the case of 40 MHz, ‘1’, |
| | | In the case of 80 MHz, ‘2’, |
| | | In the case of 160 MHz or 80 + 80 MHz, ‘3’ |
| Grouping | 2 | Indicates subcarrier grouping (Ng) used in the compressed |
| | | beamforming feedback matrix |
| | | In the case of Ng = 1(no grouping), ‘0’, |
| | | In the case of Ng = 2, ‘1’, |
| | | In the case of Ng = 4, ‘2’, |
| | | A value of ‘3’ is set to a preliminary value |
| Codebook | 1 | Indicates the sizes of codebook entries |
| Information | | When the feedback type is the SU-MIMO, |
| | | In the case of bψ = 2 and bΦ = 4, ‘0’, |
| | | In the case of bψ = 4 and bΦ = 6, ‘1’ |
| | | When the feedback type is the MU-MIMO, |
| | | In the case of bψ = 5 and bΦ = 7, ‘0’, |
| | | In the case of bψ = 7 and bΦ = 9, ‘1’ |
| | | Herein, bψ and bΦ mean the number of quantized bits |
| Feedback Type | 1 | Indicates the feedback type |
| | | In the case of the SU-MIMO, ‘0’, |
| | | In the case of the MU-MIMO, ‘1’ |
| Remaining | 3 | Indicates the number of remaining feedback segments for |
| Feedback | | the associated VHT Compressed Beamforming frame |
| Segments | | In the case of a last feedback segment of the segmented |
| | | report or a segment of an unsegmented report, the |
| | | Remaining Feedback Segments are set to ‘0’ |
| | | When the Remaining Feedback Segments are not first and |
| | | last feedback segments of the segmented report, the |
| | | Remaining Feedback Segments are set to a value between |
| | | ‘1’ and ‘6’ |
| | | When the Remaining Feedback Segments are feedback |
| | | segments other than the last segment, the Remaining |
| | | Feedback Segments are set to the value between ‘1’ and |
| | | ‘6’ |
| | | In the case of a retransmitted feedback segment, the field |
| | | is set to the same value as the segment associated with |
| | | original transmission |
| First Feedback | 1 | In the case of a first feedback segment of the segmented |
| Segment | | report or a segment of an unsegmented report, the First |
| | | Feedback Segment is set to ‘1’ |
| | | When the corresponding feedback segment is not the first |
| | | feedback segment or the VHT Compressed Beamforming |
| | | Report field or the MU Exclusive Beamforming Report |
| | | field does not exist in the frame, the First Feedback |
| | | Segment is set to ‘0’ |
| | | In the case of a retransmitted feedback segment, the field |
| | | is set to the same value as the segment associated with the |
| | | original transmission |
| Sounding | 6 | The Sounding Dialog Token Number is set to a sounding |
| Dialog Token | | dialog token value of the NDPA frame |
| Number | | |

When the VHT Compressed Beamforming frame does not transfer the entirety or a part of the VHT Compressed Beamforming Report field, the Nc Index subfield, the Channel Width subfield, the Grouping subfield, the Codebook Information subfield, the Feedback Type subfield, and the Sounding Dialog Token Number subfield are set as a preliminary field, the First Feedback Segment subfield is set to ‘0’, and the Remaining Feedback Segments subfield is set to ‘7’.

The Sounding Dialog Token field may be referred to as a Sounding Sequence Number subfield.

2) The VHT compressed beamforming report field is used for transferring explicit feedback information representing the compressed beamforming feedback matrix ‘V’ which a transmission beamformer uses a steering matrix ‘Q’ for determining in the form of an angle.

Table 6 shows the subfield of the VHT compressed beamforming report field.

TABLE 6

| | The | |
|---|---|---|
| | number | |
| Subfield | of bits | Description |
| Average SNR of Space-Time Stream 1 | 8 | Average SNR on all subcarriers for |
| | | space-time stream 1 in beamformee |
| . . . | . . . | . . . |
| Average SNR of Space-Time Stream Nc | 8 | Average SNR on all subcarriers for |
| | | the space-time stream Nc in |
| | | beamformee |
| Compressed Beamforming Feedback | Na * (bψ + | Order of the angle of Compressed |
| Matrix V for subcarrier k = scidx(0) | bΦ)/2 | Beamforming Feedback Matrix for |
| | | the corresponding subcarrier |
| Compressed Beamforming Feedback | Na * (bψ + | The order of the angle of Compressed |
| Matrix V for subcarrier k = scidx(1) | bΦ)/2 | Beamforming Feedback Matrix for |
| | | the corresponding subcarrier |
| . . . | . . . | . . . |
| Compressed Beamforming Feedback | Na * (bψ + | The order of the angle of Compressed |
| Matrix V for subcarrier k = scidx(Ns − 1) | bΦ)/2 | Beamforming Feedback Matrix for |
| | | the corresponding subcarrier |

Referring to Table 6, the VHT compressed beamforming report field may include the average SNR for each time-space stream and the Compressed Beamforming Feedback Matrix ‘V’ for the respective subcarriers. The Compressed Beamforming Feedback Matrix as a matrix including information on a channel state is used to for calculating a channel matrix (that is, a steering matrix ‘Q’) in the transmission method using the MIMO.

scidx( ) means the subcarrier in which the Compressed Beamforming Feedback Matrix subfield is transmitted. Na is fixed by a value of Nr×Nc (for example, in the case of Nr×Nc=2×1, Φ11, ψ21, . . . ).

Ns means the number of subcarriers in which the compressed beamforming feedback matrix is transmitted to the beamformer. The beamformee may reduce the Ns in which the compressed beamforming feedback matrix is transmitted by using the grouping method. For example, a plurality of subcarriers is bundled as one group and the compressed beamforming feedback matrix is transmitted for each corresponding group to reduce the number of compressed beamforming feedback matrices which are fed back. The Ns may be calculated from the Channel Width subfield and the Grouping subfield included in the VHT MIMO Control field.

Table 7 exemplifies an average SNR of space-time stream subfield.

TABLE 7

| Average SNR of Space-Time i subfield | AvgSNRᵢ | |
|---|---|---|
| −128 | ≦−10 | dB |
| −127 | −9.75 | dB |
| −126 | −9.5 | dB |
| . . . | . . . | |
| +126 | 53.5 | dB |
| +127 | ≧53.75 | dB |

Referring to Table 7, the average SNR for each time-space stream is calculated by calculating the average SNR value for all subcarriers included in the channel and mapping the calculated average SNR value to the range of −128 to +128.

3) The MU Exclusive Beamforming Report field is used to transfer the explicit feedback information shown in the form of delta (A) SNR. Information in the VHT Compressed Beamforming Report field and the MU Exclusive Beamforming Report field may be used for the MU beamformer to determine the steering matrix ‘Q’.

Table 8 shows the subfield of the MU Exclusive Beamforming Report field included in the VHT compressed beamforming report frame.

TABLE 8

| | The | |
|---|---|---|
| | number | |
| Subfield | of bits | Description |
| Delta SNR for space-time stream 1 for | 4 | Difference between the SNR for the |
| subcarrier k = sscidx(0) | | corresponding subcarrier and the |
| | | average SNR for all subcarriers of |
| | | the corresponding time-space stream |
| . . . | . . . | . . . |
| Delta SNR for space-time stream Nc for | 4 | Difference between the SNR for the |
| subcarrier k = sscidx(0) | | corresponding subcarrier and the |
| | | average SNR for all subcarriers of |
| | | the corresponding time-space stream |
| . . . | . . . | . . . |
| Delta SNR for space-time stream 1 for | 4 | Difference between the SNR for the |
| subcarrier k = sscidx(1) | | corresponding subcarrier and the |
| | | average SNR for all subcarriers of |
| | | the corresponding time-space stream |
| . . . | . . . | . . . |
| Delta SNR for space-time stream Nc for | 4 | Difference between the SNR for the |
| subcarrier k = sscidx(1) | | corresponding subcarrier and the |
| | | average SNR for all subcarriers of |
| | | the corresponding time-space stream |
| . . . | . . . | . . . |
| Delta SNR for space-time stream 1 for | 4 | Difference between the SNR for the |
| subcarrier k = sscidx(Ns′ − 1) | | corresponding subcarrier and the |
| | | average SNR for all subcarriers of |
| | | the corresponding time-space stream |
| . . . | . . . | . . . |
| Delta SNR for space-time stream Nc for | 4 | Difference between the SNR for the |
| subcarrier k = sscidx(Ns′ − 1) | | corresponding subcarrier and the |
| | | average SNR for all subcarriers of |
| | | the corresponding time-space stream |

Referring to Table 8, the SNR per time-space stream may be included for each subcarrier in the MU Exclusive Beamforming Report field.

Each Delta SNR subfield has a value which increases by 1 dB between −8 dB and 7 dB.

scidx( ) represents the subcarrier(s) in which the Delta SNR subfield is transmitted and Ns means the number of subcarriers in which the Delta SNR subfield is transmitted.

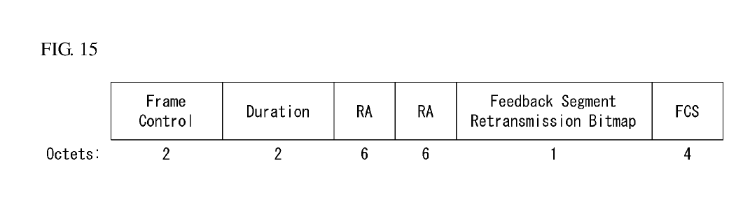

FIG. 15 is a diagram illustrating a beamforming report poll frame format in the wireless communication system to which the present invention may be applied.

Referring to FIG. 15, the Beamforming Report Poll frame is configured to include the Frame Control field, the Duration field, the Receiving Address (RA) field, the Transmitting Address (TA) field, the Feedback Segment Retransmission Bitmap field, and the FCS.

The RA field value represents the address of an intended recipient.

The TA field value represents a bandwidth for signaling the address of the STA which transmits the Beamforming Report Poll or the TA.

The Feedback Segment Retransmission Bitmap field indicates the feedback segment requested by the VHT Compressed Beamforming report.

In the Feedback Segment Retransmission Bitmap field value, when the bit of position n is ‘1’ (in the case of the LSB, n=0 and in the case of the MSB, n=7), the feedback segment corresponding to n in the Remaining Feedback Segments subfield in the VHT MIMO Control field of the VHT compressed beamforming frame is requested. On the contrary, when the bit of position n is ‘0’, the feedback segment corresponding to n in the Remaining Feedback Segments subfield in the VHT MIMO Control field is not requested.

Group ID

Since the VHT WLAN system supports the MU-MIMO transmission method for higher throughput, the AP may simultaneously transmit the data frame to one or more STAs which are MIMO-paired. The AP may simultaneously transmit data to the STA group including one or more STAs among the plurality of STAs which are associated therewith. For example, the maximum number of paired STA may be 4 and when the maximum of time-space streams is 8, a maximum of 4 time-space streams may be allocated to each STA.

Further, in the WLAN system that supports Tunneled Direct Link Setup (TDLS), Direct Link Setup (DLS), or a mesh network, the STA that intends to transmit data may transmit the PPDU to the plurality of STAs by using the MU-MIMO transmission technique.

Hereinafter, the case in which the AP transmits the PPDU to the plurality of STAs according to the MU-MIMO transmission technique will be described as an example.

The AP simultaneously transmits the PPDU to the STAs which belongs to the transmission target STA group, which are paired through different spatial streams. As described above, the VHT-SIG A field of the VHT PPDU format includes the group ID information and the time-space stream information, and as a result, each STA may verify whether the corresponding PPDU is a PPDU transmitted thereto. In this case, since the spatial stream is not allocated to a specific STA of the transmission target STA group, data may not be transmitted.

A Group ID Management frame is used in order to assign or change user positions corresponding to one or more Group IDs. That is, the AP may announce STAs connected with a specific group ID through the Group ID Management frame before performing MU-MIMO transmission.

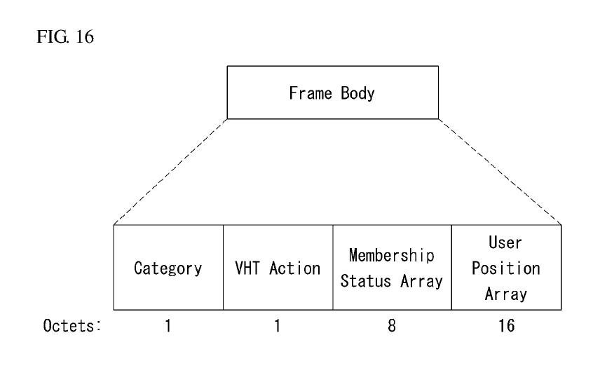

FIG. 16 is a diagram illustrating a Group ID management frame in the wireless communication system to which the present invention may be applied.

Referring to FIG. 16, the Group ID Management as the VHT action frame for supporting the VHT function includes the Action field in the frame body. The Action field provides a mechanism for specifying management operations included in and extended to the frame body of the MAC frame.

The Action field is constituted by the Category field, the VHT Action field, a Membership Status Array field, and a User Position Array field.

The Category field is set to the value indicating a VHT category (that is, VHT Action frame) and the VHT Action field is set to a value indicating the Group ID Management frame.

The Membership Status Array field is comprised of a Membership Status subfield of 1 bit for each group. When the Membership Status subfield is set to ‘0’, the Membership Status subfield indicates that the STA is not a member of the corresponding group and when the Membership Status subfield is set to ‘1’, the Membership Status subfield indicates that the STA is the member of the corresponding group. One or more Membership Status subfields in the Membership Status Array field are set to ‘1’ to allocate one or more groups to the STA.

The STA may have one user position in each group which belongs thereto. Herein, the user position indicates which position the spatial stream set of the corresponding STA corresponds to in the entire spatial stream depending on the MU-MIMO transmission when the STA belongs to the corresponding group ID.

The User Position Array field is comprised of a User Position subfield of 2 bit for each group. The user position of the STA in the group which belongs to the STA is indicated by the User Position subfield in the User Position Array field. The AP may allocate the same user position to different STAs in each group.

The AP may transmit the Group ID Management frame only when a dot11VHTOptionImplemented parameter is ‘true’. The Group ID Management frame is transmitted only to a VHT STA in which an MU Beamformee Capable field in a VHT Capabilities element field is set to ‘1’. The Group ID Management frame is transmitted to a frame addressed to each STA.

The STA receives the Group ID Management frame having the RA field which matches the MAC address thereof. The STA updates GROUP_ID_MANAGEMENT which is a PHYCONFIG_VECTOR parameter based on contents of the Group ID Management frame which are received.

Transmission of the Group ID Management to the STA and transmission of the ACK from the STA therefor are completed before transmitting the MU PPDU to the STA.

The MU PPDU is transmitted to the STA based on the contents of the Group ID Management frame most recently transmitted to the STA and the ACK is received.

DL MU-MIMO Frame

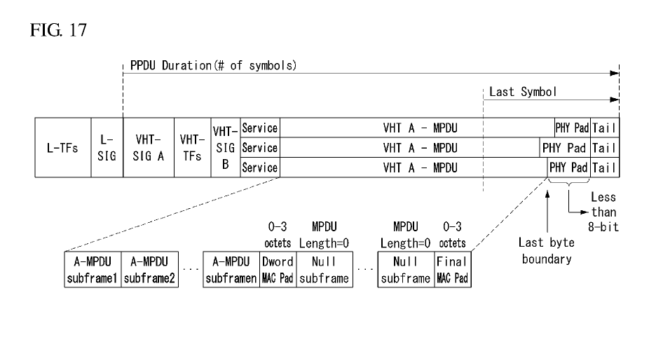

FIG. 17 is a diagram illustrating a DL multi-user (MU) PPDU format in a wireless communication system to which an embodiment of the present invention may be applied.

In FIG. 17, the number of STAs receiving a corresponding PPDU is assumed to be 3 and the number of spatial streams allocated to each STA is assumed to be 1, but the number of STAs paired with an AP and the number of spatial streams allocated to each STA are not limited thereto.

Referring to FIG. 17, the MU PPDU is configured to include L-TFs (i.e., an L-STF and an L-LTF), an L-SIG field, a VHT-SIG-A field, a VHT-TFs (i.e., a VHT-STF and a VHT-LTF), a VHT-SIG-B field, a service field, one or more PSDUs, a padding field, and a tail bit. The L-TFs, the L-SIG field, the VHT-SIG-A field, the VHT-TFs, and the VHT-SIG-B field are the same as those of FIG. 4, and a detailed description thereof is omitted.

Information for indicating PPDU duration may be included in the L-SIG field. In the PPDU, PPDU duration indicated by the L-SIG field includes a symbol to which the VHT-SIG-A field has been allocated, a symbol to which the VHT-TFs have been allocated, a field to which the VHT-SIG-B field has been allocated, bits forming the service field, bits forming a PSDU, bits forming the padding field, and bits forming the tail field. An STA receiving the PPDU may obtain information about the duration of the PPDU through information indicating the duration of the PPDU included in the L-SIG field.

As described above, group ID information and time and spatial stream number information for each user are transmitted through the VHT-SIG-A, and a coding method and MCS information are transmitted through the VHT-SIG-B. Accordingly, beamformees may check the VHT-SIG-A and the VHT-SIG-B and may be aware whether a frame is an MU MIMO frame to which the beamformee belongs. Accordingly, an STA which is not a member STA of a corresponding group ID or which is a member of a corresponding group ID, but in which the number of streams allocated to the STA is ‘0’ is configured to stop the reception of the physical layer to the end of the PPDU from the VHT-SIG-A field, thereby being capable of reducing power consumption.

In the group ID, an STA can be aware that a beamformee belongs to which MU group and it is a user who belongs to the users of a group to which the STA belongs and who is placed at what place, that is, that a PPDU is received through which stream by previously receiving a group ID management frame transmitted by a beamformer.

All MPDUs transmitted in the VHT MU PPDU based on 802.11ac are included in the A-MPDU. In the data field of FIG. 17, an upper box exemplifies the VHT A-MPDU transmitted to STA 1, a middle box exemplifies the VHT A-MPDU transmitted to STA 2, and a lower box exemplifies the VHT A-MPDU transmitted to STA 3.

The A-MPDU is configured to include one or more consecutive A-MPDU subframes and an end-of-frame pad having a length of 0 to 3 octets.

Each A-MPDU subframe may be configured to include one MPDU delimiter field and thereafter, selectively include the MPDU. Each A-MPDU subframe which is not positioned last in the A-MPDU has a pad field so that the length of the subframe becomes the multiple of 4 octets.

In FIG. 17, the A-MPDUs may have different bit sizes because the size of data transmitted to each STA may be different.

In this case, null padding may be performed so that the time when the transmission of a plurality of data frames transmitted by a beamformer is ended is the same as the time when the transmission of a maximum interval transmission data frame is ended. The maximum interval transmission data frame may be a frame in which valid downlink data is transmitted by a beamformer for the longest time. The valid downlink data may be downlink data that has not been null padded. For example, the valid downlink data may be included in the A-MPDU and transmitted. Null padding may be performed on the remaining data frames other than the maximum interval transmission data frame of the plurality of data frames.

For the null padding, a beamformer may fill one or more A-MPDU subframes, temporally placed in the latter part of a plurality of A-MPDU subframes within an A-MPDU frame, with only an MPDU delimiter field through encoding.

When the EOF field is detected in the MAC layer of an STA on the receiving side, the reception of the physical layer is stopped, thereby being capable of reducing power consumption.

Block Ack Procedure

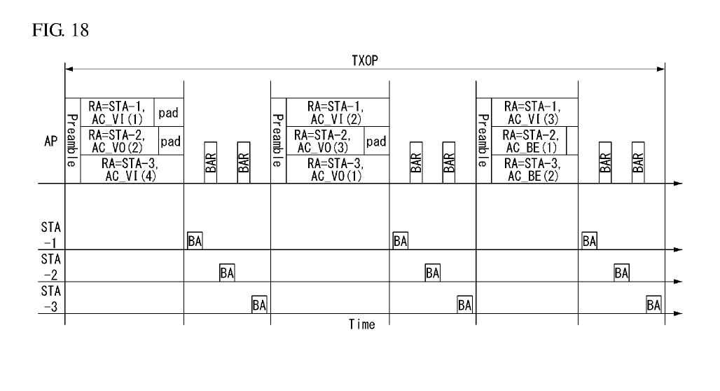

FIG. 18 is a diagram illustrating a downlink MU-MIMO transmission process in the wireless communication system to which the present invention may be applied.

In 802.11ac, the MU-MIMO is defined in downlink toward the client (that is, non-AP STA) from the AP. In this case, a multi-user frame is simultaneously transmitted to multiple receipients, but reception acknowledgement needs to be individually transmitted in uplink.

Since all MPDUs transmitted in the VHT MU PPDU based on 802.11ac are included in the A-MPDU, not an immediate response to the VHT MU PPDU but a response to the A-MPDU in the VHT MU PPDU is transmitted in response to a block Ack request (BAR) frame by the AP.

First, the AP transmits the VHT MU PPDU (that is, a preamble and data) to all receipients (that is, STA 1, STA 2, and STA 3). The VHT MU PPDU includes the VHT A-MPDU transmitted to each STA.

STA 1 that receives the VHT MU PPDU from the AP transmits a block acknowledgement (ACK) frame to the AP after the SIFS. More detailed description of the BA frame will be made below.

The AP that receives the BA from STA 1 transmits block acknowledgement request (BAR) to next STA 2 after the SIFS and STA 2 transmits the BA frame to the AP after the SIFS. The AP that receives the BA frame from STA 2 transmits the BAR frame to STA 3 after the SIFS and STA 3 transmits the BA frame to the AP after the SIFS.

When such a process is performed with respect to all STAs, the AP transmits the next MU PPDU to all STAs.

Multi-User Uplink Data Transmitting Method

IEEE 802.11ax as a next-generation WLAN system for supporting higher data rate and processing a higher user load is one of WLAN systems that have been newly proposed in recent years is called high efficiency WLAN (HEW).

The IEEE 802.11ax WLAN system may operate in a 2.4 GHz frequency band and a 5 GHz frequency band similarly to the existing WLA system. Further, the IEEE 802.11ax WLAN system may operate even in 6 GHz or a 60 GHz frequency band higher therethan.

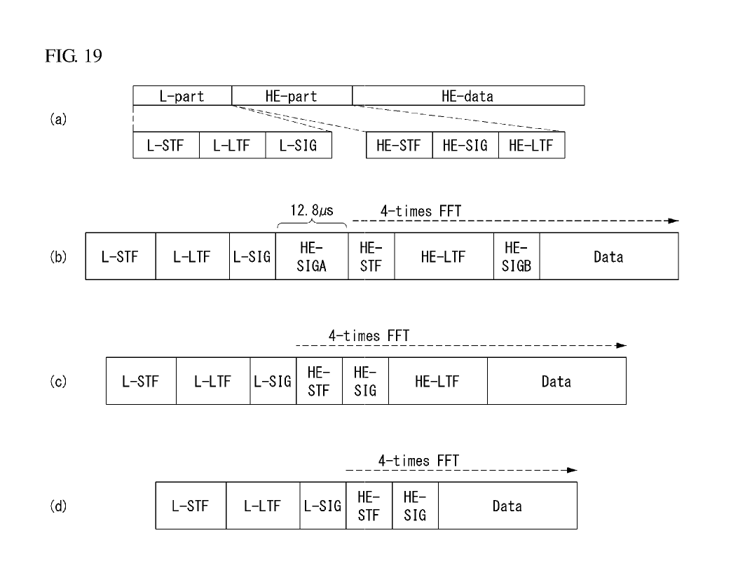

FIGS. 19 to 23 are diagrams illustrating a high efficiency (HE) format PPDU according to an embodiment of the present invention.

FIG. 19(a) illustrates a schematic structure of the HE format PPDU and FIGS. 19(b) to 19(d) illustrates a more detailed structure of the HE format PPDU.

Referring to FIG. 19(a), the HE format PPDU for the HEW may be generally comprised of a legacy part L-part, an HE part HE-part, and a data field HE-data.

The L-part is constituted by an L-STF field, an L-LTF field, and an L-SIG field similarly to a form maintained in the existing WLAN system.

The HE-part as a part which is newly defined for the 802.11ax standard may include an HE-STF field, an HE-SIG field, and an HE-LTF field. In FIG. 19(a), the order of the HE-STF field, the HE-SIG field, and the HE-LTF field is illustrated, but the HE-STF field, the HE-SIG field, and the HE-LTF field may be configured in a different order therefrom. Further, the HE-LTF may be omitted.

The HE-SIG may include information (for example, OFDMA, UL MU MIMO, enhanced MCS, and the like) for decoding the HE-data field.

The L-part and the HE-part may have different fast Fourier transform (FFT) sizes (that is, subcarrier spacing) and use different cyclic prefixes (CPs).

Referring to FIG. 19(b), the HE-SIG field may be divided into an HE-SIG A field and an HE-SIG B field.

For example, the HE-part of the HE format PPDU may include an HE-SIG A field having a length of 12.8 μs, an HE-STF field of 1 OFDM symbol, one or more HE-LTF fields, and an HE-SIG B field of 1 OFDM symbol.

Further, in the HE-part, FFT having a size which is four times larger than the existing PPDU may be applied from the HE-STF field except for the HE-SIG A field. That is, FFT having sizes of 256, 512, 1024, and 2048 may be applied from the HE-STF fields of the HE format PPDUs of 20 MHz, 40 MHz, 80 MHz, and 160 MH, respectively.

However, as illustrated in FIG. 19(b), when the HE-SIG is transmitted while being divided into the HE-SIG A field and the HE-SIG B field, the positions of the HE-SIG A field and the HE-SIG B field may be different from those of FIG. 18(b). For example, the HE-SIG B field may be transmitted after the HE-SIG A field, and the HE-STF field and the HE-LTF field may be transmitted after the HE-SIG B field. Similarly even in this case, FFT having a size which is four times larger than the existing PPDU may be applied from the HE-STF field.

Referring to FIG. 19(c), the HE-SIG field may not be divided into the HE-SIG A field and the HE-SIG B field.

For example, the HE-part of the HE format PPDU may include the HE-STF field of 1 OFDM symbol, the HE-SIG field of 1 OFDM symbol and one or more HE-LTF fields.

Similarly thereto, the FFT having a size which is four times larger than the existing PPDU may be applied from the HE-part. That is, the FET having sizes of 256, 512, 1024, and 2048 may be applied from the HE-STF fields of the HE format PPDUs of 20 MHz, 40 MHz, 80 MHz, and 160 MH, respectively.

Referring to FIG. 19(d), the HE-SIG field may not be divided into the HE-SIG A field and the HE-SIG B field and the HE-LTF field may be omitted.

For example, the HE-part of the HE format PPDU may include the HE-STF field of 1 OFDM symbol and the HE-SIG field of 1 OFDM symbol.

Similarly thereto, the FFT having a size which is four times larger than the existing PPDU may be applied to the HE-part. That is, the FFT having sizes of 256, 512, 1024, and 2048 may be applied from the HE-STF fields of the HE format PPDUs of 20 MHz, 40 MHz, 80 MHz, and 160 MH, respectively.

The HE format PPDU for the WLAN system according to the present invention may be transmitted through at least one 20-MHz channel. For example, the HE format PPDU may be transmitted in the 40 MHz, 80 MHz, or 160 MHz frequency band through a total of four 20-MHz channel. This will be described in more detail with reference to a drawing given below.

Hereinafter, the described PPDU format is described based on FIG. 19(b) for easy description, but the present invention is not limited thereto.

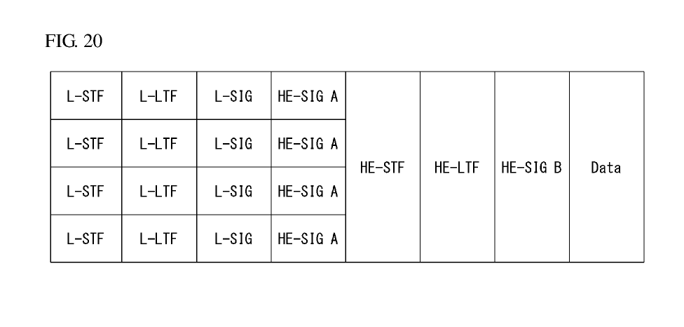

FIG. 20 is a diagram illustrating an HE format PPDU according to an embodiment of the present invention.

In FIG. 20, the PPDU format when 80 MHz is allocated to one STA or when different streams of 80 MHz are allocated to the plurality of STAs, respectively is illustrated.

Referring to FIG. 20, the L-STF, the L-LTF, and the L-SIG may be transmitted to the OFDM symbol generated based on 64 FFT points (alternatively, 64 subcarriers) in each 20-MHz channel

The HE-SIG A field may include common control information commonly transmitted to the STAs receiving the PPDU. The HE-SIG A field may be transmitted in one to three OFDM symbols. The HE-SIG A field is duplicated by the unit of 20 MHz and includes the same information. Further, the HE-SIG-A field announces total bandwidth information of the system.

Table 9 is a diagram illustrating information included in the HE-SIG A

### FIELD

TABLE 9

| | The | |
|---|---|---|
| | number | |
| | of | |
| Field | bits | Description |
| Bandwidth | 2 | Indicates the bandwidth in which the PDDU is transmitted |
| | | For example, 20 MHz, 40 MHz, 80 MHz, or 160 MHz |
| Group ID | 6 | Indicates the STA or the group of the STAs which will |
| | | receive the PPDU |
| Stream information | 12 | Indicates the position or the number of the spatial stream for |
| | | each STA, or indicates the position or the number of the |
| | | spatial stream for the group of the STAs |
| UL indication | 1 | Indicates whether the PPDU is transmitted toward the AP |
| | | (uplink) or the STA (downlink) |
| MU indication | 1 | Indicates whether the PPDU is the SU-MIMO PPDU or the |
| | | MU-MIMO PPDU |
| GI indication | 1 | Indicates whether a short GI or a long GI is used |
| Allocation | 12 | Indicates a band or channel (subchannel index or subband |
| information | | index) allocated to each STA in a band in which the PPDU |
| | | is transmitted |
| Transmission power | 12 | Indicates transmission power for each channel or each STA |

The information included in the respective fields may follow the definition of the IEEE 802.11 system. Further, the respective fields correspond to examples of the fields which may be included in the PPDU and are not limited thereto. That is, each field may be substituted with another field or further include an additional field and all fields may not be requisitely included.

The HE-STF is used to enhance performance of AGC estimation in MIMO transmission.

The HE-SIG B field may include user-specific information required for each STA to receive data (for example, PSDU) thereof. The HE-SIG B field may be transmitted in one or two OFDM symbols. For example, the HE-SIG B field may include a modulation and coding scheme (MCS) of the corresponding PSDU and information on the length of the PSDU.

The L-STF, L-LTF, L-SIG, and HE-SIG A fields may be repeatedly transmitted by the unit of the 20-MHz channel. For example, when the PPDU is transmitted through four 20-MHz channels (that is, 80-MHz band), the L-STF, L-LTF, L-SIG, and HE-SIG A fields may be repeatedly transmitted by the unit of the 20-MHz channel.

When the size of the FFT increases, the legacy STA supporting the existing IEEE 802.11a/g/n/ac may not decode the corresponding HE PPDU. The L-STF, L-LTF and L-SIG fields are transmitted through 64 FFT in the 20-MHz channel so as to be received by the legacy STA so that the legacy STA and the HE STA coexist. For example, the L-SIG field may occupy one OFDM symbol, one OFDM symbol time may be 4 μs, and the GI may be 0.8 μs.

The FFT size for each frequency unit may further increase from the HE-STF (alternatively, HE-SIG A). For example, 256 FFT may be used in the 20-MHz channel, 512 FFT may be used in the 40-MHz channel, and 1024 FET may be used in the 80-MHz channel. When the FET size increases, an interval between OFDM subcarriers decreases, and as a result, the number of OFDM subcarriers per frequency increases, but the OFDM symbol time is lengthened. For improvement the efficiency of the system, the length of the GI after the HE-STF may be set to be the same as the length of the GI of the HE-SIG A.

The HE-SIG A field may include information required for the HE STA to decode the HE PPDU. However, the HE-SIG A field may be transmitted in the 20-MHz channel through 64 FFT so as to be received by both the legacy STA and the HE STA. The reason is that the HE STA may receive the existing HT/VHT format PPDU as well as the HE format PPDU, and the legacy STA and the HE STA need to distinguish the HT/VHT format PPDU and the HE format PPDU.

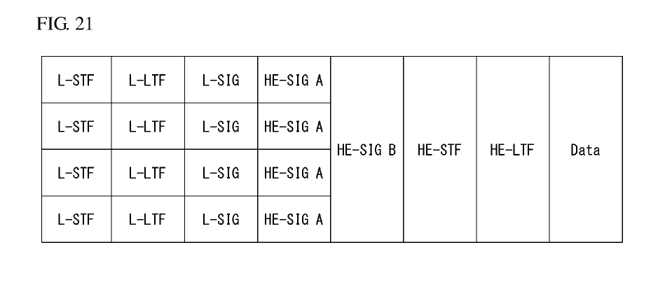

FIG. 21 is a diagram illustrating an HE format PPDU according to an embodiment of the present invention.

Referring to FIG. 21, the example is the same as the example of FIG. 20 except the HE-SIG B field is positioned after the HE-SIG A field. In this case, the FFT size per frequency may further increase from the HE-STF (alternatively, HE-SIG B). For example, 256 FFT may be used in the 20-MHz channel from the HE-STF (alternatively, HE-SIG B), 512 FET may be used in the 40-MHz channel, and 1024 FFT may be used in the 80-MHz channel.

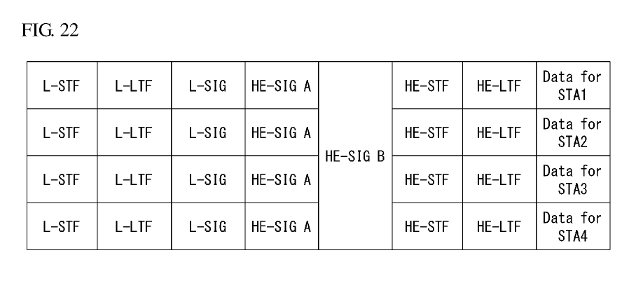

FIG. 22 is a diagram illustrating an HE format PPDU according to an embodiment of the present invention.

In FIG. 22, a case in which 20-MHz channels are allocated to different STAs (for example, STA 1, STA 2, STA 3, and STA 4), respectively is assumed.

Referring to FIG. 22, the HE-SIG B field is positioned after the HE-SIG A field. In this case, the FFT size per frequency may further increase from the HE-STF (alternatively, HE-SIG B). For example, 256 FFT may be used in the 20-MHz channel from the HE-STF (alternatively, HE-SIG B), 512 FFT may be used in the 40-MHz channel, and 1024 FFT may be used in the 80-MHz channel.

Since the information transmitted in each field included in the PPDU is the same as the example of FIG. 20, description of the information will be hereinafter omitted.

The HE-SIG B field may include information specific to each STA, but be encoded throughout all bands (that is, indicated in the HE-SIG A field). That is, the HE-SIG B field includes information on all STAs and all STAs receive the HE-SIG B

### FIELD

The HE-SIG B field may announce frequency bandwidth information allocated for each STA and/or stream information in the corresponding frequency band. For example, in FIG. 22, in the HE-SIG B, 20 MHz may be allocated to STA 1, the next 20 MHz may be allocated to STA 2, the next 20 MHz may be allocated to STA 3, and the next 20 MHz may be allocated to STA 4. Further, 40 MHz may be allocated to STA 1 and STA 2 and the next 40 MHz may be allocated to STA 3 and STA 4. In this case, different streams may be allocated to STA 1 and STA 2 and different streams may be allocated to STA 3 and STA 4.

Further, the HE-SIG C field is defined to add the HE-SIG C field to the example of FIG. 22. In this case, in the HE-SIG B field, information on all STAs may be transmitted throughout all bands and control information specific to each STA may be transmitted by the unit of 20 MHz through the HE-SIG C field.

Further, in the examples of FIGS. 20 to 22, the HE-SIG B field may not be transmitted through all bands but transmitted by the unit of 20 MHz similarly to the HE-SIG A field. This will be described in detail with reference to the following drawings.

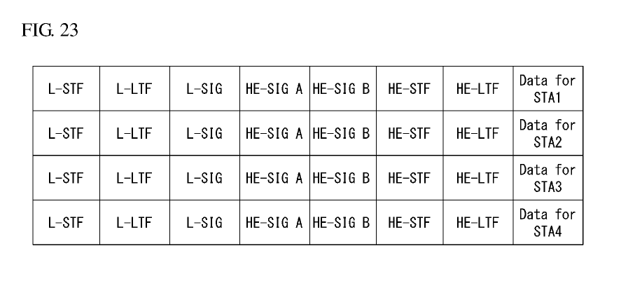

FIG. 23 is a diagram illustrating an HE format PPDU according to an embodiment of the present invention.

In FIG. 23, the case in which 20-MHz channels are allocated to different STAs (for example, STA 1, STA 2, STA 3, and STA 4), respectively is assumed.

Referring to FIG. 23, the HE-SIG B field is positioned after the HE-SIG A field, similarly to FIG. 22. However, the HE-SIG B field is not transmitted throughout all bands, but transmitted by the unit of 20 MHz similarly to the HE-SIG A field.

In this case, the FET size per frequency may further increase from the HE-STF (alternatively, HE-SIG B). For example, 256 FFT may be used in the 20-MHz channel from the HE-STF (alternatively, HE-SIG B), 512 FFT may be used in the 40-MHz channel, and 1024 FFT may be used in the 80-MHz channel

Since the information transmitted in each field included in the PPDU is the same as the example of FIG. 20, description of the information will be hereinafter omitted.

The HE-SIG A field is transmitted while being duplicated by the unit of 20 MHz.

The HE-SIG B field may announce the frequency bandwidth information allocated for each STA and/or the stream information in the corresponding frequency band.

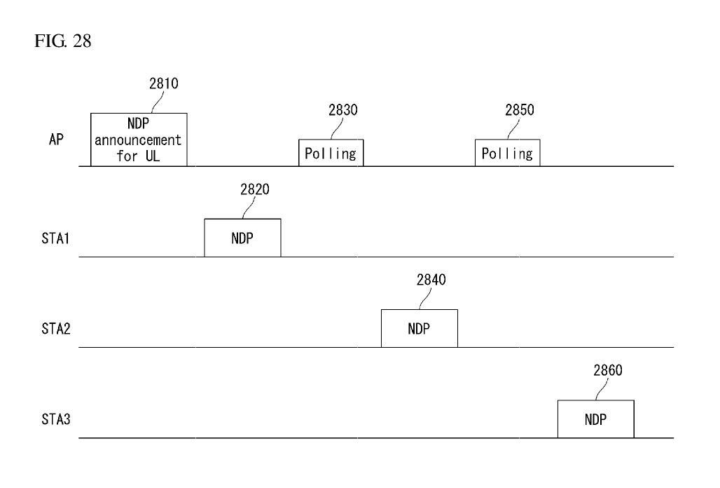

The HE-SIG B field is transmitted by the unit of 20 MHz similarly to the HE-SIG A field. In this case, since the HE-SIG B field includes the information on each STA, the information on each STA may be included for each HE-SIG B field of the unit of 20 MHz. In this case, in the example of FIG. 28, the case in which 20 MHz is allocated for each STA is exemplified, but for example, when 40 MHz is allocated to the STA, the HE-SIG B field may be duplicated and transmitted by the unit of 20 MHz.

Further, the information (that is, all information specific to the respective STAs is combined) on all STAs is included in the HE-SIG B field to be duplicated and transmitted by the unit of 20 MHz similarly to the HE-SIG A field.

Like the examples of FIGS. 21 to 23, when the HE-SIG B field is positioned before the HE STF field and the HE LTF field, the length of the symbol may be configured to be short by using 64 FFT at 20 MHz, and like the example of FIG. 20, when the HE-SIG B field is positioned after the HE STF field and the HE LTF field, the length of the symbol may be configured to be long by using 256 FFT at 20 MHz.

When a partial bandwidth having a low interference level from an neighboring BSS is allocated to the STA in an environment in which different bandwidths are supported for each BSS, it may be more preferable not to transmit the HE-SIG B field throughout all bands as described above.

In FIGS. 20 to 23, the data field as a payload may include a Service field, a scrambled PSDU, tail bits, and padding bits.

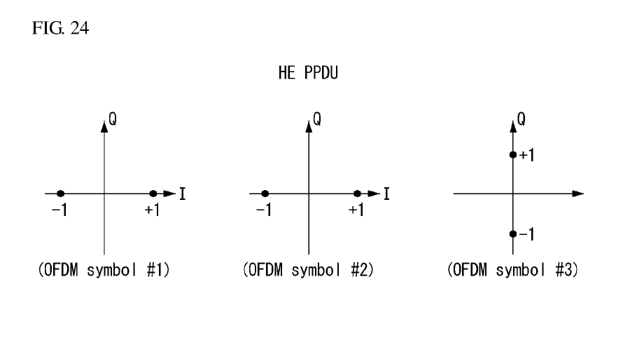

FIG. 24 illustrates phase rotation for HE format PPDU detection according to an embodiment of the present invention.

In order to classify the HE format PPDU, phases of 3 OFDM symbols transmitted after the L-SIG field may be used in the HE format PPDU.

Referring to FIG. 24, the phases of OFDM symbol #1 and OFDM symbol #2 transmitted after the L-SIG field do not rotate in the HE format PPDU, but the phase of OFDM symbol #3 may rotate at 90° counterclockwise. That is, as a demodulation method of OFDM symbol #1 and OFDM symbol #2, BPSK may be used as the demodulation method of OFDM symbol #3, QBPSK may be used.

The STA attempts decoding the first to third OFDM symbols transmitted after the L-SIG field of the received PPDU based on a constellation illustrated in the example of FIG. 24. When the STA succeeds in decoding, the STA may determine that the corresponding PPDU is the HE format PPDU.

Herein, when the HE-SIG A field is transmitted in 3 OFDM symbols after the L-SIG field, this means that all of OFDM symbol #1 to OFDM symbol #3 are used for transmitting the HE-SIG A field.

Hereinafter, the multi-user uplink data transmitting method in the WLAN system will be described.

A scheme in which Further, the plurality of STAs which operates in the wireless LAN system transmits data to the AP on the same time resource may be referred to as ‘uplink multi-user (UL MU) transmission.

Uplink transmission by the plurality of respective STAs may be multiplexed in a frequency domain or a spatial domain.

When the uplink transmission by the plurality of respective STAs is multiplexed in the frequency domain, different frequency resources may be allocated to the plurality of respective STAs as uplink transmission resources based on orthogonal frequency division multiplexing (OFDMA). The transmission method through the different frequency resources may be referred to as ‘UL MU OFDMA transmission’.

When the uplink transmission by the plurality of respective STAs is multiplexed on the spatial domain, different spatial streams may be allocated to the plurality of respective STAs and the plurality of respective STAs may transmit the uplink data through the different spatial streams. The transmission method through the different spatial streams may be referred to as ‘UL MU MIMO transmission’.

At present, UL MU transmission may not be supported due to the following constraints in the WLAN system.

At present, in the WLAN system, synchronization with a transmission timing of the uplink data transmitted from the plurality of STAs is not supported. For example, when the case where the plurality of STAs transmits the uplink data through the same time resource in the existing WLAN system is assumed, the plurality of respective STAs may not know the transmission timing of the uplink data of another STA in the WLAN system at present. Accordingly, it is difficult for the AP to receive the uplink data on the same time resource from the plurality of respective STAs.

Further, frequency resources used for transmitting the uplink data may overlap with each other by the plurality of STAs in the WLAN system at present. For example, when oscillators of the plurality of respective STAs are different from each other, frequency offsets may be expressed to be different from each other. When the plurality of respective STAs in which the frequency offsets are different simultaneously performs the uplink transmission through different frequency resources, some of frequency areas used by the plurality of respective STAs may overlap with each other.

Further, in the existing WLAN system, power control for the plurality of respective STAs is not performed in the existing WLAN system. The AP may receive signals having different powers from the plurality of respective STAs dependently to distance and channel environments between each of the plurality of STAs and the AP. In this case, it may relatively more difficult for the AP to detect a signal which reaches with weak power than a signal which reaches with strong power.

As a result, the present invention proposes the UL MU transmission method in the WLAN system.

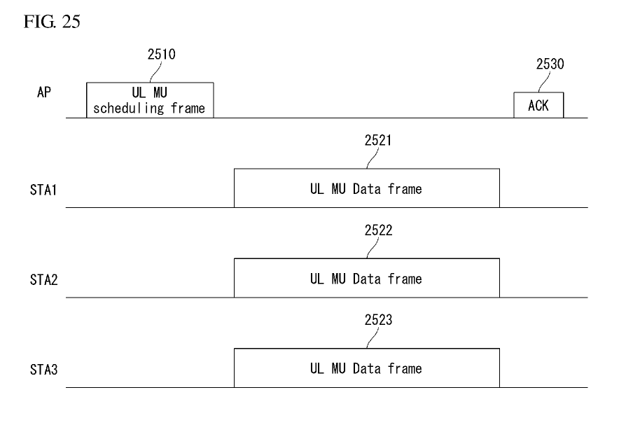

FIG. 25 is a diagram illustrating an uplink multi-user transmission procedure according to an embodiment of the present invention.

Referring to FIG. 25, the AP indicates preparing for the UL MU transmission to the STAs which participate in the UL MU transmission, receives a UL MU data frame from the corresponding STAs, and transmits the ACK frame in response to the UL MU data frame.

First, the AP transmits a UL MU scheduling frame 2510 to indicate preparing for the UL MU transmission to the STAs that will transmit the UL MU data. Herein, the UL MU scheduling frame may also be called a term such as ‘UL MU trigger frame’ or ‘trigger frame’.

Herein, the UL MU scheduling frame 2510 may include control information including STA identifier (ID)/address information, resource allocation information, duration information, and the like.

The STA ID/address information means information on an identifier or address for specifying each STA that transmits the uplink data.

The resource allocation information means information on an uplink transmission resource (for example, frequency/subcarrier information allocated to each STA in the case of the UL MU OFDMA transmission and a stream index allocated to each STA in the case of the UL MU MIMO transmission) allocated for each STA.

The duration information means information for determining a time resource for transmitting the uplink data frame transmitted by the plurality of respective STAs. Hereinafter, the duration information is referred to as ‘MAC duration’.

For example, the MAC duration may include interval information of a transmit opportunity (TXOP) allocated for uplink transmission of each STA, or information (for example, a bit or symbol) on the length of the uplink frame.

Further, the UL MU scheduling frame 2510 may further include control information, including MCS information, coding information, and the like to be used at the time of transmitting the UL MU data frame for each STA.

The control information may be transmitted in the HE-part (for example, the HE-SIG A field or HE-SIG B field) of the PPDU transferring the scheduling frame 2510 or a control field (for example, the frame control field of the MAC frame, and the like) of the UL MU scheduling frame 2510.

The PPDU transferring the UL MU scheduling frame 2510 has a structure which starts with the L-part (for example, the L-STF field, the L-LTF field, the L-SIG field, and the like). As a result, the legacy STAs may perform network allocation vector (NAV) setting from the L-SIG field. For example, the legacy STAs may calculate a duration (hereinafter, ‘L-SIG protection duration’) for the NAV setting based on data length and data rate information in the L-SIG In addition, the legacy STAs may determine that there is no data transmitted thereto during the calculated L-SIG protection duration.

For example, the L-SIG protection duration may be determined as the sum of an MAC duration value of the UL MU scheduling frame 2510 and a residual duration after the L-SIG field in the PPDU transferring the UL MU scheduling frame 2510. As a result, the L-SIG protection duration may be set to a value up to a duration in which an ACK frame 2530 transmitted to each STA is transmitted according to the MAC duration value of the UL MU scheduling frame 2510.

Hereinafter, the resource allocation method for UL MU transmission to each STA will be described in more detail. For easy description, the field including the control information is distinguished and described, but the present invention is not limited thereto.

A first field may distinguish and indicate the UL MU OFDMA transmission and the UL MU MIMO transmission. For example, in the case of ‘0’, the first field may indicate the UL MU OFDMA transmission and in the case of ‘1’, the first field may indicate the UL MU MIMO transmission. The size of the first field may be configured by 1 bit.

A second field (for example, STA ID/address field) announces STA IDs or STA addresses that will participate in the UL MU transmission. The size of the second field may be configured by the number of bits for announcing the STA ID x the number of STAs which will participate in UL MU. For example, when the second field is configured by 12 bits, the second field may indicate the ID/address of each STA for each 4 bit.

A third field (for example, resource allocation field) indicates a resource area allocated to each STA for the UL MU transmission. In this case, the resource area allocated to each STA may be sequentially indicated to each STA according to the order of the second field.

When the first field value is ‘0’, the third field value represents frequency information (for example, a frequency index, a subcarrier index, and the like) for the UL MU transmission in the order of the STA ID/address included in the second field and when the first field value is ‘1’, the third field value represents MIMO information (for example, a stream index, and the like) for the UL MU transmission in the order of the STA ID/address included in the second field.

In this case, since multiple indexes (that is, the frequency/subcarrier index or stream index) may be known to one STA, the size of the third field may be configured by a plurality of bits (alternatively, may be configured in a bitmap format) x the number of STAs which will participate in the UL MU transmission.

For example, it is assumed that the second field is set in the order of ‘STA 1’ and ‘STA 2’ and the third field is set in the order of ‘2’ and ‘2’.

In this case, when the first field is ‘1’, the frequency resource may be allocated to STA 1 from a higher (alternatively, lower) frequency domain the next frequency resource may be sequentially allocated to STA 2. As one example, when 20 MHz-unit OFDMA is supported in the 80 MHz band, STA may use a higher (alternatively, lower) 40 MHz band and STA 2 may use the next 40 MHz band.

On the contrary, when the first field is ‘1’, a higher (alternatively, lower) may be allocated to STA 1 and the next stream may be sequentially allocated to STA 2. In this case, a beamforming scheme depending on each stream may be predesignated or more detailed information on the beamforming scheme depending on the stream may be included in the third field or a fourth field.

Each STA transmits UL MU data frames 2521, 2522, and 2523 to the AP based on the UL MU scheduling frame 2510 transmitted by the AP. Herein, each STA may receive the UL MU scheduling frame 2510 and thereafter, transmit the UL MU data frames 2521, 2522, and 2523 to the AP after the SIFS.

Each STA may determine a specific frequency resource for the UL MU OFDMA transmission and the spatial stream for the UL MU MIMO transmission based on the resource allocation information of the UL MU scheduling frame 2510.

In detail, in the case of the UL MU OFDMA transmission, the respective STAs may transmit the uplink data frame on the same time resource through different frequency resources.

Herein, respective STA 1 to STA3 may be allocated with different frequency resources for transmitting the uplink data frame based on the STA ID/address information and the resource allocation information included in the UL MU scheduling frame 2510. For example, the STA ID/address information may sequentially indicate STA 1 to STA 3 and the resource allocation information may sequentially indicate frequency resource 1, frequency resource 2, and frequency resource 3. In this case, STA 1 to STA 3 sequentially indicated based on the STA ID/address information may be allocated with frequency resource 1, frequency resource 2, and frequency resource 3 sequentially indicated based on the resource allocation information, respectively. That is, STA 1, STA 2, and STA 3 may transmit the uplink data frames 2521, 2522, and 2523 to the AP through frequency 1, frequency 2, and frequency 3, respectively.

Further, in the case of the UL MU MIMO transmission, the respective STAs may transmit the uplink data frame on the same time resource through one or more different streams among the plurality of spatial streams.

Herein, respective STA 1 to STA3 may be allocated with the spatial streams for transmitting the uplink data frame based on the STA ID/address information and the resource allocation information included in the UL MU scheduling frame 2510. For example, the STA ID/address information may sequentially indicate STA 1 to STA 3 and the resource allocation information may sequentially indicate spatial stream 1, spatial stream 2, and spatial stream 3. In this case, STA 1 to STA 3 sequentially indicated based on the STA ID/address information may be allocated with spatial stream 1, spatial stream 2, and spatial stream 3 sequentially indicated based on the resource allocation information, respectively. That is, STA 1, STA 2, and STA 3 may transmit the uplink data frames 2521, 2522, and 2523 to the AP through spatial stream 1, spatial stream 2, and spatial stream 3, respectively.

As described above, a transmission duration (alternatively, a transmission end time) of the uplink data frames 2521, 2522, and 2523 transmitted by each STA may be determined by the MAC duration information included in the UL MU scheduling frame 2510. Accordingly, each STA may synchronize the transmission end time of the uplink data frames 2521, 2522, and 2523 (alternatively, the uplink PPDU transferring the uplink data frames) through bit padding or fragmentation based on the MAC duration value included in the UL MU scheduling frame 2510.

The PPDU transferring the uplink data frames 2521, 2522, and 2523 may be configured even in a new structure without the L-part.

Further, in the case of the UL MU MIMO transmission or UL MU OFDMA transmission of a subband type less than 20 MHz, the L-part of the PPDU transferring the uplink data frames 2521, 2522, and 2523 may be transmitted in an SFN scheme (that is, all STAs simultaneously transmit the same L-part configuration and content). On the contrary, in the case of the UL MU OFDMA transmission of a subband type equal to or more than 20 MHz, the L-part of the PPDU transferring the uplink data frames 2521, 2522, and 2523 may be transmitted by the unit of 20 MHz in the band to which each STA is allocated.

As described above, the MAC duration value in the UL MU scheduling frame 2510 may be set to a value up to a duration in which the ACK frame 2530 is transmitted and the L-SIG protection section may be determined based on the MAC duration value. Accordingly, the legacy STA may perform the NAV setting up to the ACK frame 2530 through the L-SIG field of the UL MU scheduling frame 2510.

When the uplink data frame may be sufficiently configured with the information of the UL MU scheduling frame 2510, the SIG field (that is, an area in which control information for a configuration scheme of the data frame) in the PPDU transferring the UL MU scheduling frame 2510 may not also be required. For example, the HE-SIG A field and/or the HE-SIG B field may not be transmitted. Further, the HE-SIG A field and the HE-SIG C field may be transmitted and the HE-SIG B field may not be transmitted.

The AP may transmit the ACK frame 2530 in response to the uplink data frames 2521, 2522, and 2523 received from each STA. Herein, the AP may receive the uplink data frames 2521, 2522, and 2523 from each STA and transmit the ACK frame 2530 to each STA after the SIFS.

When the existing structure of the ACK frame is similarly used, AIDs (alternatively, partial AID) of the STAs which participate in the UL MU transmission may be configured to be included in the RA field having a size of 6 octets.

Alternatively, when the ACK frame having a new structure is configured, the ACK frame may be configured in a form for the DL SU transmission or DL MU transmission. That is, in the case of the DL SU transmission, the ACK frame 2530 may be sequentially transmitted to the respective STAs which participate in the UL MU transmission, and in the case of the DL MU transmission, the ACK frame 2530 may be simultaneously transmitted to the respective STAs which participate in the UL MU transmission through the resources (that is, the frequencies or streams) allocated to the respective STAs.

The AP may transmit only the ACK frame 2530 for the UL MU data frame which is successfully received to the corresponding STA. Further, the AP may announce whether the UL MU data frame is successfully received as ACK or NACK through the ACK frame 2530. When the ACK frame 2530 includes NACK information, the ACK frame 2530 may include even a reason for the NACK or information (for example, the UL MU scheduling information, and the like) for a subsequent procedure.

Alternatively, the PPDU transferring the ACK frame 2530 may be configured in a new structure without the L-part.

The ACK frame 2530 may include the STA ID or address information, but when the order of the STAs indicated by the UL MU scheduling frame 2510 is similarly applied, the STA ID or address information may be omitted.

Further, a frame for next UL MU scheduling or a control frame including correction information for the next UL MU transmission, and the like may be included in the TXOP by extending the TXOP (that is, the L-SIG protection duration) of the ACK frame 2530.

Meanwhile, an adjustment process such as synchronizing the STAs, or the like may be added for the UL MU transmission.

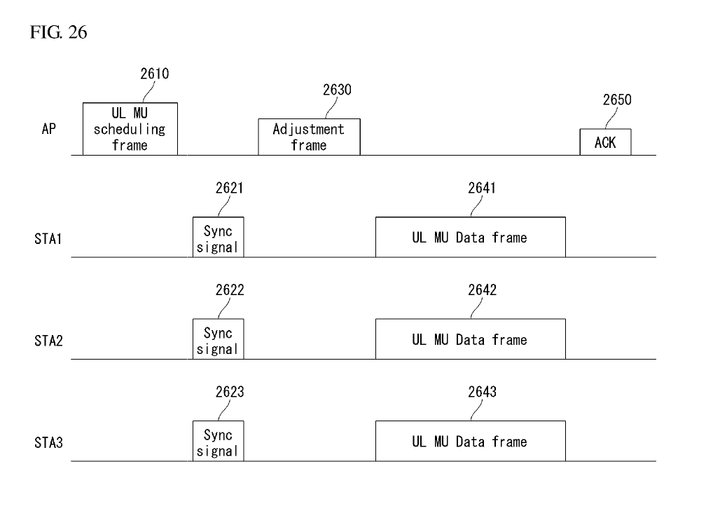

FIG. 26 is a diagram illustrating the uplink multi-user transmission procedure according to an embodiment of the present invention.

Hereinafter, for easy description, the same description as the example of FIG. 25 will be omitted.

Referring to FIG. 26, the AP may indicate the STAs which will be used for the UL MU to prepare for the UL MU, and receive the UL MU data frame and transmit the ACK after the adjustment process such as synchronizing the STAs for the UL MU, or the like.

First, the AP transmits a UL MU scheduling frame 2610 to indicate preparing for the UL MU transmission to the STAs that will transmit the UL MU data.

Each STA that receives the UL MU scheduling frame 2610 from the AP transmits sync signals 2621, 2622, and 2623 to the AP. Herein, each STA may receive the UL MU scheduling frame 2610 and transmit the sync signals 2621, 2622, and 2623 to the AP after the SIFS.

In addition, the AP that receives the sync signals 2621, 2622, and 2623 from each STA transmits an adjustment frame 2630 to each STA. Herein, the AP may receive the sync signals 2621, 2622, and 2623 and transmit the adjustment frame 2630 after the SIFS.

A procedure of transceiving the synchronization signals 2621, 2622, and 2623 and the adjustment frame 2630 is a procedure for adjusting the time/frequency/power, and the like among the respective STAs for transmitting the UL MU data frame. That is, the procedure is a procedure in which the STAs transmit the sync signals 2621, 2622, and 2623 thereof and the AP announces adjustment information to adjust errors including the time/frequency/power, and the like based on the values to each STA through the adjustment frame 2630 to adjust and transmit the values in the UL MU data frame to be transmitted next. Further, the procedure is performed after the UL MU scheduling frame 2610, and as a result, the STA may have a time to prepare for configuring the data frame according to scheduling.

In more detail, the STAs indicated in the UL MU scheduling frame 2610 transmit the sync signals 2621, 2622, and 2623 to resource areas indicated or designated thereby, respectively. Herein, the sync signals 2621, 2622, and 2623 transmitted from each STA may be multiplexed by time division multiplexing (TDM), code division multiplexing (CDM), and/or spatial division multiplexing (SDM) schemes.

For example, when the order of the STAs indicated by the UL MU scheduling frame 2610 is STA 1, STA 2, and STA 3 and the sync signals 2621, 2622, and 2623 of each STA are multiplexed by the CDM, Sequence 1, Sequence 2, and Sequence 3 which are allocated may be transmitted to the AP in the order of the designated STAs, respectively.

Herein, the resources (for example, the time/sequence/stream, and the like) to be used by each STA may be indicated or defined to each STA in advance so as to multiplex and transmit the sync signals 2621, 2622, and 2623 of each STA by the TDM, the CDM, and/or the SDM.

Further, the PPDU transferring the sync signals 2621, 2622, and 2623 may be included the L-part, or be transmitted by only a physical layer signal without configuring the MAC frame.

The AP that receives the sync signals 2621, 2622, and 2623 from each STA transmits the adjustment frame 2630 to each STA.

In this case, the AP may transmit the adjustment frame 2630 to each STA by the DL SU transmission scheme or transmit the adjustment frame 2630 to each STA by the DL MU transmission scheme. That is, in the case of the DL SU transmission, the adjustment frame 2630 may be sequentially transmitted to the respective STAs which participate in the UL MU transmission and in the case of the DL MU transmission, the adjustment frame 2630 may be simultaneously transmitted to the respective STAs which participate in the UL MU transmission through the resources (that is, the frequencies or streams) allocated to the respective STAs.

The adjustment frame 2630 may include the STA ID or address information, but when the order of the STAs indicated by the UL MU scheduling frame 2610 is similarly applied, the STA ID or address information may be omitted.

Further, the adjustment frame 2630 may include an adjustment field.

The adjustment field may include information for adjusting the errors including the time/frequency/power, and the like. Herein, the errors including the time/frequency/power, and the like may occur in the signals of the STAs, which are received by the AP and the adjustment information means information for announcing an error gap to be adjusted. Besides, even any information to more accurately adjust the errors including the time/frequency/power, and the like of each STA based on the sync signals 2621, 2622, and 2623 received by the AP may be included in the adjustment frame 2630.

The PPDU transferring the adjustment frame 2630 may be configured in a new structure without the L-part.

Meanwhile, a procedure of transceiving the sync signals 2621, 2622, and 2623 and the adjustment frame 2630 may be performed before transmitting the UL MU scheduling frame 2610 of each STA.

Further, transmission of the sync signals 2621, 2622, and 2623 may be omitted and the AP may transmit the UL MU scheduling frame 2610 including the adjustment information through implicit measurement. For example, in a pre-procedure to be described below, the AP may generate the adjustment information to adjust the errors including the time/frequency/power, and the like among the respective STAs through the NDP or buffer status/sounding frame transmitted from each STA and transmit the adjustment information to each STA through the UL MU scheduling frame 2610.

Further, a procedure in which STAs (for example, a case in which an adjustment procedure among the respective STAs that will perform the UL MU transmission is previously completed, and the like) of which adjustment is not required transceive the sync signals 2621, 2622, 2623 and the adjustment frame 2630 may be omitted.

Further, when only a partial adjustment procedure is required, only the procedure may be adjusted. For example, when the cyclic prefix (CP) length of the UL MU data frame is as long as asychronization among the STAs does not become an issue, a procedure for adjusting a time difference may be omitted. Alternatively, when the UL MU OFDMA transmission is performed, if a guard band between the STAs is sufficient, a procedure for adjusting a frequency difference may be omitted.

Each STA transmits UL MU data frames 2641, 2642, and 2643 to the AP based on the UL MU scheduling frame 2610 and the adjustment frame 2630 transmitted by the AP. Herein, each STA may receive the adjustment frame 2630 from the AP and thereafter, transmit the UL MU data frames 2641, 2642, and 2643 to the AP after the SIFS.

The AP may transmit an ACK frame 2650 as a response to the uplink data frames 2641, 2642, and 2643 received from each STA. Herein, the AP may receive the uplink data frames 2641, 2642, and 2643 from each STA and transmit the ACK frame 2650 to each STA after the SIFS.

In FIGS. 25 and 26, a structure of UL MU transmission associated downlink PPDU including the UL MU scheduling frame, the adjustment frame, the ACK frame, and the like may be configured based on 20 MHz. This will be described in more detail with reference to a drawing given below.

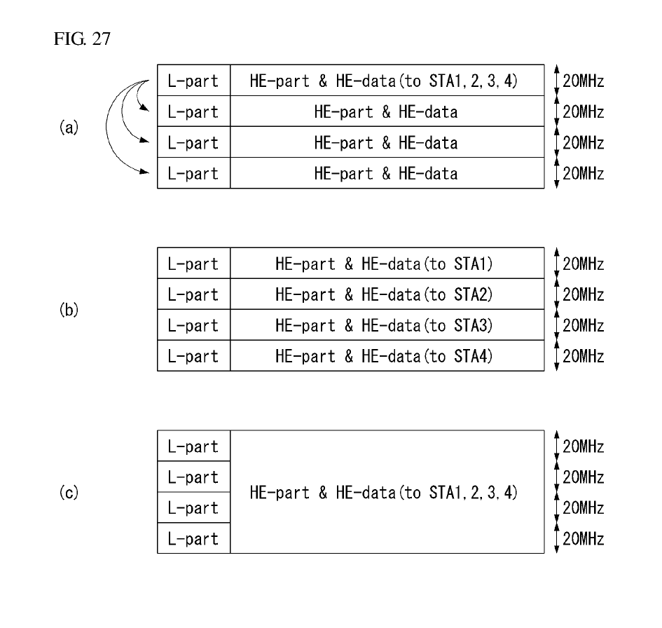

FIG. 27 is a diagram illustrating a downlink PPDU structure associated with uplink multi-user transmission according to an embodiment of the present invention.

In FIG. 27, it is assumed that the full band is 80 MHz and the bandwidth is allocated by the unit of 20 MHz for each STA for the UL OFDMA transmission.

Referring to FIG. 27(a), all information of STAs of the UL MU is included in the 20 MHz PPDU and the same information may be copied and transmitted to other 20 MHz channels.

When a primary channel is configured in the corresponding BSS, the STA first verifies information in the primary channel configured in the corresponding BSS, and as a result, the information of the STAs of the UL MU transmission may be transmitted only in the primary 20 MHz channel. However, in this case, when interference occurs in the corresponding primary channel due to an neighboring BSS, the information may be lost.

Each STA may read all available channels according to a capability thereof. For example, when STA 1 is an STA that supports the 40 MHz band, STA 1 may read first and second channels from the top. Further, when STA 4 is an STA that supports the 80 MHz band, STA 4 may read all four channels.

Accordingly, it may be preferable to transmit information on all STAs in all channels for each 20 MHz as illustrated in FIG. 27(a) in order to prevent such a problem. That is, even though the information is lost in a specific channel due to the interference, the information may be successfully transmitted through other channels.

Referring to FIG. 27(b), information regarding the UL MU transmission of the respective STAs to be allocated for each 20 MHz may be transmitted.

Further, when the 40 MHz channel is allocated to STA 1 unlike FIG. 27(b), the information may be transmitted through the 40 MHz channel in a PPDU structure in which the information is copied to STA 1 by the unit of 20 MHz. Further, the information may be transmitted in the 40 MHz PPDU structure.

As described above, each STA may verify the information transmitted thereto by reading all available channels according to the capability thereof.

The case of FIG. 27(b) may be preferable when the primary channel is not configured in the corresponding BSS.

Referring to FIG. 27(c), the HE-part other than the L-part and the data may be transmitted in a full-band PPDU structure.

This case may be preferable when the AP knows that all terminals associated with the UL MU support 80 MHz in advance.

The bandwidths including 80 MHz, 20 MHz, and the like illustrated in FIG. 27 are just exemplary values for easy description and the present invention is not limited thereto.

Further, a part (for example, at least any one of the HE-SIG A field, the HE-STF field, the HE-LTF field, and the HE-SIG B field) of the HE-part may follow the structure of the L-part. That is, a part of the HE-part may be continuously configured by the unit of 20 MHz.

Further, the UL MU associated DL PPDU may have different structures for each frame. For example, the UL MU scheduling frame may follow a structure in which the UL MU scheduling frame is copied to all bands by the unit of 20 MHz, and as a result, the same information is transmitted to all bands as illustrated in FIG. 27(a) and the downlink ACK frame may be transmitted only through one 20 MHz-unit PPDU in FIG. 27(a).

Meanwhile, the DL PPDU structure associated with the UL MU transmission according to FIG. 27 is described by assuming the case in which the channel is allocated by the unit of 20 MHz for each STA in the UL MU OFDMA transmission for easy description, but the above method may be similarly applied even to the case of the UL MU MIMO transmission.

For example, when 20 MHz-unit stream 1 to stream 4 are sequentially allocated to STA 1 to STA 4 at 20 MHz and the UL MU MIMO transmission is performed, the information on all STAs may be included and transmitted in each stream as illustrated in FIG. 27(a).

Further, as illustrated in FIG. 27(b), for each 20 MHz-unit stream, only information on an STA to which the corresponding stream is allocated may be included and transmitted.

In addition, when 80 MHz-unit UL MU MIMO transmission is supported for each STA at full-band 80 MHz, the information on all STAs may be included and transmitted for each 80 MHz-unit stream as illustrated in FIG. 27(c).

However, the PPDU structure illustrated in FIG. 27(a) may be preferable in order to support both the UL MU OFDMA transmission and the UL MU MIMO transmission. For example, in order to support the 20 MHz-unit UL MU OFDMA transmission for each STA at the full-band 80 MHz, the PPDU may be configured like the example of FIG. 27(a) and in order to support the 5 MHz-unit or 20 MHz-unit UL MU MIMO transmission for each STA at the full-band 20 MHz, only one 20 MHz PPDU structure in the example of FIG. 27(a) may be transmitted. In this case, DL frame structures associated with the UL MU OFDMA transmission and the UL MU MIMO transmission may be configured through the same PPDU structure.

A pre-procedure for the UL MU transmission is required for the UL MU transmission.

The pre-procedure means a step of preparing for reporting channel states of the STAs and/or the buffer status of the STAs required for the UL MU transmission, and the like.

Herein, buffer status information may include information on which format data which the STA will transmit uplink has (for example, access category (AC) information (for example, voice, video, data, and the like), how many the data are accumulated in a queue (for example, the size of the uplink data, the size of the queue in which the uplink data are accumulated, and the like), how urgent the uplink data is transmitted (for example, backoff count, a contention window value, and the like), and the like.

1) Method Using NDP Procedure

The pre-procedure the UL MU transmission may be performed by using the NDP similarly to the example of FIG. 11. That is, the NDP is received from each STA which participates in the UL MU transmission, and as a result, the AP may acquire the uplink channel state information and/or buffer status information for each STA. This will be described with reference to drawings.

FIG. 28 is a diagram illustrating a pre-procedure for the uplink multi-user transmission according to an embodiment of the present invention.

In FIG. 28, a case in which three STAs (STA 1, STA 2, and STA 3) participate in the UL MU transmission is assumed.

Referring to FIG. 28, the AP transmits a null data packet announcement (NDPA) frame 2810 to each STA which participates in the UL MU transmission for a buffer status/sounding request.

Herein, the NDPA frame 2810 may be configured in the same format as the example of FIG. 12.

However, in order to distinguish the NDPA frame 2810 from the NDPA frame used for the existing downlink sounding procedure, the NDPA frame 2810 may notify announcement for the UL MU transmission by using the reserved bit (for example, reserved 2 bits of the sounding dialog token field).

The NDPA frame 2810 includes an STA Info field including information on a target STA which participates in the UL MU. One STA Info field may be included for each sounding target STA and the AID for identifying the target STA which participates in the UL MU transmission is included in the AID12 subfield.

Further, the NDPA frame 2810 may further include the resource allocation field for the UL MU transmission. Alternatively, the resource allocation information for the UL MU transmission allocated to each STA may be transmitted by using the Nc Index subfield of the STA Info field. Hereinafter, the field including the resource allocation information is collectively called the ‘resource allocation field’.

The resource allocation field indicates a resource area (for example, frequency/subcarrier information for each STA to report the channel state in the case of the UL MU OFDMA transmission and a stream index for each STA to report the channel state in the case of the UL MU MIMO transmission) for reporting a frequency/stream channel state of each STA for the UL MU transmission. In this case, the resource area allocated to each STA may be sequentially indicated to each STA according to the order of the AID12 subfield.

In the case of the UL MU MIMO transmission, the spatial stream allocated to each STA may be indicated based on n AID12 subfields and resource allocation fields. Further, in the case of the UL MU OFDMA transmission, the frequency resources allocated to the plurality of respective STAs may be indicated based on n AID12 subfields and resource allocation fields.

STAs that receive the NDPA frame 2810 may verify the AID12 subfield value included in the STA Info field and verify whether the STAs are the target STA for the UL MU transmission.

Further, the STAs may know the order of the NDP transmission through the order of the STA Info field included in the NDPA. In FIG. 28, a case in which NDPs 2820, 2840, and 2860 are transmitted to the AP in the order of STA 1, STA 2, and STA 3 is illustrated.

Each of the STAs may transmit the NDPs 2820, 2840, and 2860 to the AP through the resource area (for example, frequency/subcarrier information for each STA to report the channel state in the case of the UL MU OFDMA transmission and a stream index for each STA to report the channel state in the case of the UL MU MIMO transmission) indicated by the NDPA frame 2810.

First, STA 1 that receives the NDPA frame 2810 transmits the NDP 2820 to the AP.

STA 1 may receive the NDPA frame 2810 and transmit the NDP 2820 to the AP after the SIFS.

Herein, the NDPs 2820, 2840, and 2860 transmitted by each STA are configured by similarly using the NDP format transmitted by the AP. However, the VHT-LTF field (alternatively, the HE-LTF field) of the NDPs 2820, 2840, and 2860 transmitted by each STA may be included as large as the resource area (as large as the number of frequencies/streams) indicated by the NDPA frame 2810.

The AP acquires the uplink channel state information based on the training field (for example, the VHT-LTF field or the HE-LTF field) of the NDP 2820 received from STA 1.

Next, the AP transmits a beamforming report poll frame 2830 to STA 2 in order to acquire the uplink channel information from STA 2.

The AP may receive the NDP from STA 1 and transmit the beamforming report poll frame 2830 to STA 2 after the SIFS.

Herein, the beamforming report poll frames 2830 and 2850 may be configured in the same format as the example of FIG. 15.

STA 2 that receives the Beamforming Report Poll frame 2830 transmits the NDP 2840 to the AP.

Herein, STA 2 may receive the Beamforming Report Poll frame 2830 and transmit the NDP 2840 to the AP after the SIFS.

Next, similarly to the process for STA 2, the AP transmits the beamforming report poll frame 2850 to STA 3 in order to acquire the uplink channel information from STA 3 and STA 3 that receives the beamforming report poll frame 2850 transmits the NDP 2860 to the AP.

The AP may acquire the channel state information and/or buffer status information through the NDP received from each STA. In addition, the AP may allocate the UL MU resources (for example, the stream for each STA in the case of the UL MU MIMO and the frequency/subcarrier for each STA in the case of the UL MU OFDMA) to each STA based on the acquired information.

2) Method for Configuring New Frame

The pre-procedure for the UL MU transmission may be performed by using a newly configured frame unlike the example of FIG. 28. That is, the new frame for acquiring the uplink channel state information and buffer status information may be defined without using the existing defined NDPA frame or NDP. This will be described with reference to the following drawings.

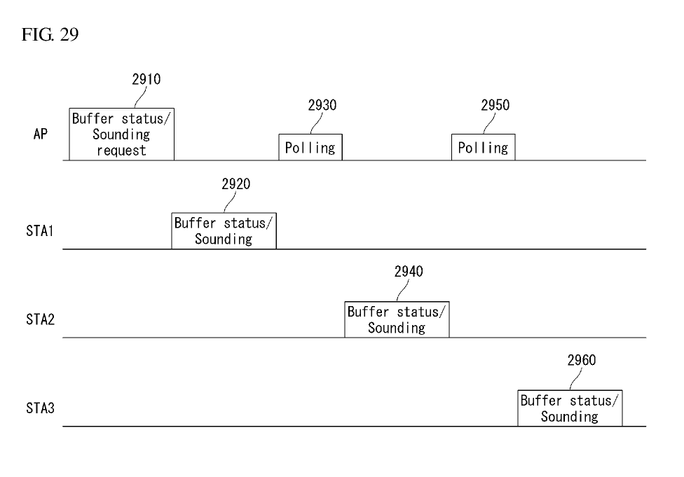

FIG. 29 is a diagram illustrating a pre-procedure for the uplink multi-user transmission according to an embodiment of the present invention.

In FIG. 29, the case in which three STAs (STA 1, STA 2, and STA 3) participate in the UL MU transmission is assumed.

Referring to FIG. 29, the AP transmits a buffer status request (BSR)/sounding request (SR) frame 2910 to each STA for the buffer status/sounding request to each STA which participates in the UL MU transmission.

Herein, the BSR/SR frame 2910 includes an ID (for example, AID) and/or address of the target STA which participates in the UL MU.

Further, the BSR/SR frame 2910 may include information for the target STA which participates in the UL MU to report the buffer status and transmit the sounding frame to the AP. In addition, the information may be included in the order of the STAs that transmit the buffer status (BS)/sounding frame.

Moreover, the BSR/SR frame 2910 may further include the resource allocation field for the UL MU transmission.

The resource allocation field indicates a resource area (for example, the frequency/subcarrier information for each STA to report the channel state in the case of the UL MU OFDMA transmission and the stream index for each STA to report the channel state in the case of the UL MU MIMO transmission) for reporting the frequency/stream channel state of each STA for the UL MU transmission. In this case, the resource area allocated to each STA may be sequentially indicated to each STA according to the order of the STA ID/address.

In the case of the UL MU MIMO transmission, the spatial stream allocated to each STA may be indicated based on n STA ID/address and resource allocation fields. Further, in the case of the UL MU OFDMA transmission, the frequency resources allocated to the plurality of respective STAs may be indicated based on n STA ID/address and resource allocation fields.

Each of the STAs transmits buffer status (BS)/sounding frames 2920, 2940, and 2960 to the AP. Herein, the STAs may know the transmission order of the BS/sounding frames 2920, 2940, and 2960 through the order of the STA ID/address information included in the BSR/SR frame 2910. In FIG. 29, a case in which the BS/sounding frames 2920, 2940, and 2960 are transmitted to the AP in the order of STA 1, STA 2, and STA 3 is illustrated.

Each of the STAs may transmit the BS/sounding frames 2920, 2940, and 2960 to the AP through a resource area (for example, frequency/subcarrier information for each STA to report the channel state in the case of the UL MU OFDMA transmission and a stream index for each STA to report the channel state in the case of the UL MU MIMO transmission) indicated by the BSR/SR frame 2910.

First, STA 1 that receives the BSR/SR frame 2910 transmits the BS/sounding frame 2920 to the AP.

STA 1 may receive the BSR/SR frame 2910 and transmit the BS/sounding 2920 to the AP after the SIFS.

Herein, the BS/sounding frames 2920, 2940, and 2960 transmitted by each STA may include the training field (for example, the VHT-LTF field or HE-LTF field) for buffer status information and sounding. For example, the buffer status information may be included in the Frame Control field and the LTF field (for example, the VHT-LTF field or HE-LTF field) may be included as large as the resource area (that is, as large as the number of frequencies/streams) indicated by the BSR/SR frame 2910.

Further, each STA may transmit the BS/sounding frames 2920, 2940, and 2960 (for example, the Frame Control field) including information required for configuring the UL MU transmission instead of transmitting the training field for the sounding. For example, each STA may transmit the BS/sounding frames 2920, 2940, and 2960 (for example, the Frame Control field) including information such as the number of streams preferred by each STA, the beamforming matrix, an MCS configuration, the position of the subcarrier, and the like.

Next, the AP transmits a polling frame 2930 to STA 2 in order to acquire the uplink channel information from STA 2.

The AP may receive the BS/sounding frame 2920 from STA 1 and transmit the polling frame 2930 to STA 2 after the SIFS.

The polling frame means a frame that helps the next STA to transmit the BS/sounding frame. When the BS/sounding frame is not received within a predetermined time (for example, SIFS), the AP may transmit the polling frame so that the next STA transmits the BS/sounding frame.

STA 2 that receives the polling frame 2930 transmits the BS/sounding frame 2940 to the AP.

Herein, STA 2 may receive the polling frame 2930 and transmit the BS/sounding 2940 to the AP after the SIFS.

Next, similarly to the process for STA 2, the AP transmits the polling frame 2950 to STA 3 in order to acquire the uplink channel information from STA 3 and STA 3 that receives the polling frame 2930 transmits the BS/sounding frame 2960 to the AP.

The AP may acquire the channel state information and/or buffer status information through the BS/sounding frame received from each STA. In addition, the AP may allocate the UL MU resources (for example, the stream for each STA in the case of the UL MU MIMO and the frequency/subcarrier for each STA in the case of the UL MU OFDMA) to each STA based on the acquired information.

Meanwhile, in the example of FIG. 29, the PPDU transferring the respective frames (the BSR/SR frame, the BS/sounding frame, and the polling frame) may include or not include the L-part. When the PPDU does not include the L-part, the PPDU may be constituted only by the HE-SIG field (alternatively, the HE-SIG A and the HE-SIG B), the HE-STF, and the HE-LTF and when the PSDU additionally exists, the PPDU may include the data field.

For example, only the PPDU transferring the BSR/SR frame which is a first transmitted frame includes the L-part to allow the legacy STA to perform the NAV setting based on the L-SIG field and the PPDU transferring other frames may be configured without the L-part. In this case, the L-SIG field value may be set as a value up to a duration in which the BS/sounding frame is received from the last STA.

3) Scheme of Updating Control Field Included in Existing Frame without Configuring New Frame

The pre-procedure for the UL MU transmission may be performed by updating the frame control field included in the MAC frame used in the related art without configuring the new frame.

For example, when the frame including the VHT control field (see FIG. 10) is used, the reserved bit in the VHT control field is configured for the UL MU (for example, set to ‘1’), and as a result, other buffer status information to transmit and receive the control information of the VHT control field may also be included. That is, when the reserved bit in the VHT control field is not configured for the UL MU, the reserved bit may be used similarly to the existing frame configuration and when the reserved bit is configured for the UL MU, the reserved bit may be used for the pre-procedure for the UL MU transmission.

In this case, the AP may configure the reserved bit in the VHT control field for the UL MU and the MRQ subfield is set to ‘1’ to request the buffer status/sounding.

The STA changes fields not required for the UL MU transmission to fields for the UL MU transmission together the existing other information by receiving a request from the AP through the VHT control field (that is, an involuntary transmission case) or voluntary determination (that is, a voluntary transmission case) to perform buffer status/sounding reporting. For example, 6 bits indicating the buffer status information including access category (access category) information (2 bits) and data size (4 bits) may be included instead of GID 6 bits (an MFSI/GID-L subfield and a GID-H subfield in FIG. 10).

Further, a buffer status for each STA may be checked by using a signal (alternatively, frame) which is periodically transmitted, such as a beacon frame, or the like.

For example, the AP may make the channel state and/or buffer status request information to be included in the beacon frame and thereafter, receives a report of the buffer status from each STA by using a contention free-poll (CF-poll) frame, and the like, or indicate the uplink frame including the channel state and/or buffer status to be transmitted by using the CF-poll frame, and the like. In this case, the AP may make the channel state and/or buffer status request information to be always included in the beacon frame or included only when needed.

For example, when the pre-procedure for the UL MU transmission is performed by using the null data packet announcement (NDPA) frame, the NDPA fame may be configured as follows.

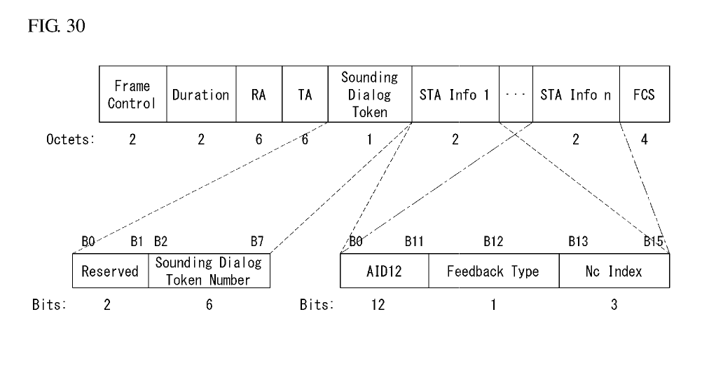

FIG. 30 is a diagram illustrating a null data packet announcement (NDPA) frame according to an embodiment of the present invention.

Referring to FIG. 30, the NDPA frame may be comprised of the frame control field, the duration field, the receiving address (RA) field, the transmitting address (TA) field, the sounding dialog token field, the STA information 1 (STA Info 1) field to the STA information n (STA Info n) field, and the FCS.

The RA field value represents a receiver address or STA address that receives the NDPA frame.

When the NDPA frame includes one STA Info field, the RA field value may have an address of the STA identified by the AID in the STA Info field. For example, when the NDPA frame is transmitted to one target STA for DL SU-MIMO or UL SU-MIMO channel sounding, the AP transmits the NDPA frame to the target STA by unicast.

On the contrary, when the NDPA frame includes one or more STA Info fields, the RA field value may have a broadcast address. For example, when the NDPA frame is transmitted to one or more target STAs for DL MU MIMO/OFDMA or UL MU MIMO/OFDMA channel sounding, the AP broadcasts the NDPA frame.

The TA field value represents a transmitter address for transmitting the NDPA frame or an address of the STA which transmits the NDPA frame, or a bandwidth signaling TA.

The Sounding Dialog Token field (alternatively, Sounding Sequence field) may be constituted by a Reserved subfield and a Sequence Number subfield.

The Sounding Dialog Token field may include information indicating whether the pre-procedure is the pre-procedure (that is, sounding reporting and/or buffer status information reporting) for the UL MU transmission or the pre-procedure (that is, sounding reporting) for the DL MU transmission.

Table 10 is a table showing the Sounding Dialog Token field according to an embodiment of the present invention.

TABLE 10

| | The | |
|---|---|---|
| | number | |
| | of | |
| Subfield | bits | Description |
| Reserved | 2 | In the case of the legacy STA, this field |
| | | is disregarded. I the case of 80.11ax STA |
| | | (that is, HE STA), this field is interpreted |
| | | as follows. |
| | | ‘0’: DL beamforming (alternatively, DL MU) |
| | | ‘1’: UL beamforming (alternatively, UL MU) |
| Sounding | 6 | Value selected by beamformer in order to |
| Dialog Token | | identify the NDPA frame |
| Number | | |

Referring to Table 10, the legacy STA disregards the Reserved subfield.

When the Reserved subfield value is ‘0’, the HE STA interprets the case as DL beamforming (that is, DL MU transmission). In addition, as described above, the downlink channel is estimated through the NDP (alternatively, beamforming report poll frame) to feed back channel information to the AP through the VHT Compressed Beamforming frame.

On the contrary, when the Reserved subfield value is ‘1’, the HE STA interprets the case as UL beamforming (that is, UL MU transmission). In addition, each STA transmits the uplink packet or frame to the AP so that the AP estimates the uplink channel

Each STA Info field may be comprised of an AID12 subfield, a Feedback Type subfield, and an Nc Index subfield.

Table 11 is a table showing the STA Info field according to an embodiment of the present invention.

TABLE 11

| | The | |
|---|---|---|
| | number | |
| | of | |
| Subfield | bits | Description |
| AID12 | 12 | Includes the AID of the STA which becomes the sounding feedback |
| | | target |
| | | When the target STA is the AP, a mesh STA, or the STA which is an |
| | | IBSS member, the AID12 subfield value is set to ‘0’ |
| Feedback Type | 1 | Indicates the feedback request type for the sounding target STA |
| | | In the case of SU, ‘0’ |
| | | In the case of MU, ‘1’ |
| Nc Index | 3 | When interpreted as the DL beamforming (that is, DL MU) |
| | | through the Reserved subfield of the Sounding Dialog Token field |
| | | in the legacy STA and the 802.11ax STA (that is, HE STA), Nc |
| | | Index is interpreted as follows. |
| | | When the Feedback Type subfield indicates the MU-MIMO, Nc |
| | | Index indicates a value acquired by subtracting 1 from the number |
| | | (Nc) of columns of the compressed beamforming feedback matrix |
| | | In the case of Nc = 1, ‘0’ |
| | | In the case of Nc = 2, ‘1’, |
| | | . . . |
| | | In the case of Nc = 8, ‘7’ |
| | | In the case of the SU-MIMO, the Nc Index is set as the Reserved |
| | | subfield |
| | | When interpreted as the UL beamforming through the Reserved |
| | | subfield of the Sounding Dialog Token field in the 802.11ax STA |
| | | (that is, HE STA), Nc Index is interpreted as follows. |
| | | The number of sounding streams which each STA needs to transmit |

Referring to Table 11, the Nc Index subfield may include different information according to the DL MU transmission or the UL MU transmission.

First, when the Reserved subfield value of the Sounding Dialog Token field is ‘0’ (that is, in the case of the DL MU transmission), the Nc Index subfield includes the number Nc of columns of a compressed beamforming feedback matrix (in the case of the MU-MIMO) or is configured as the Reserved subfield (in the case of the SU-MIMO).

Accordingly, the legacy STA or the 802.11ax STA (that is, HE STA) feeds back to the AP the downlink channel information estimated through the NDP (alternatively, beamforming report poll frame) received from the AP according to the Nc Index subfield value.

On the contrary, when the Reserved subfield value of the Sounding Dialog Token field is ‘1’ (that is, in the case of the UL MU transmission), the Nc Index subfield includes the number of sounding streams which each STA needs to transmit.

Herein, the number of sounding streams is interpreted as a meaning that the NDP including the LTF fields (for example, HE-LTF or HE-midamble) as large as the number of corresponding sounding streams is transmitted.

Accordingly, the 802.11ax STA (that is, HE STA) transmits the NDP including the LTF fields as large as the number of streams indicated by the Nc Index subfield to the AP so that the AP estimates the uplink channel. In this case, even though the STA capability supports a maximum of 4 streams, when the AP commands the STA to transmit the NDP including the LTF fields for two streams through the Nc Index subfield, the corresponding STA transmits the NDP including the LTF fields for two streams indicated by the Nc Index subfield.

The third scheme described up to now may be configured together with the first scheme or the second scheme. For example, the channel information may be transceived by the first scheme and the buffer status information may be transceived by the third scheme.

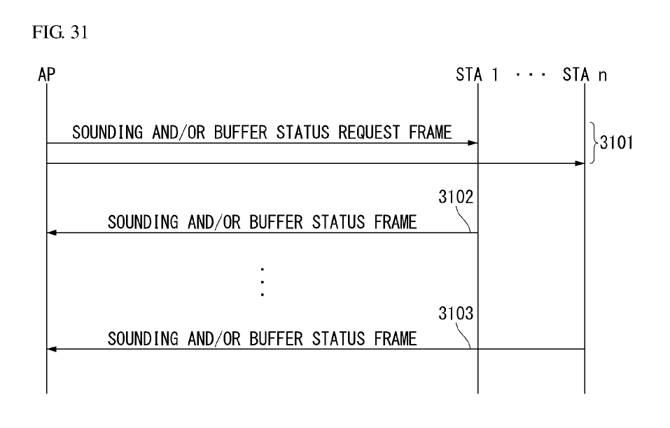

FIG. 31 is a diagram illustrating a pre-procedure for the uplink multi-user transmission according to an embodiment of the present invention.

Referring to FIG. 31, the AP transmits a sounding and/or buffer status request frame to STA 1 to STA n (n is 2 or more) which participate in the UL MU transmission (S3101).

As the sounding and/or buffer status request frame, the VHT Null Data Packet Announcement (NDPA) frame, the beacon frame, and the like may be used. Further, as described above, the new frame is not defined and the frame control field of the existing MAC frame may be updated and used. Further, a newly defined buffer status request/sounding request frame may be used.

The sounding and/or buffer status request frame may include information indicating the number of streams to which each STA needs to transmit the sounding and/or buffer status frame.

Further, the sounding and/or buffer status request frame may include order information in which each STA will transmit the sounding and/or buffer status frame. For example, the sounding and/or buffer status request frame may include the sounding stream number information according to the order information of the respective STAs.

When the existing VHT Null Data Packet Announcement (NDPA) frame is used as the sounding and/or buffer status request frame, the sounding and/or buffer status request frame may include information for distinguishing whether the sounding and/or buffer status request frame is the frame for the DL MU transmission or the frame for the UL MU transmission.

STA 1 to STA n that receive the sounding and/buffer status request frame transmits the sounding and/or buffer status frame to the AP (S3102).

STA 1 to STA n may transmit the sounding and/or buffer status frame to the AP in order according to the order information indicated by the sounding and/or buffer status request frame.

Further, STA 1 to STA n may transmit to the AP the sounding and/or buffer status frame including the number of LTE symbols (for example, HE-LTF or HE-midamble) as large as the number of streams indicated by the sounding and/or buffer status request frame.

Meanwhile, the PPDU transferring the sounding and/or buffer status request frame may include the L-part so that the legacy STA may perform the NAV setting based on the L-SIG field value, but the PPDU transferring the sounding and/or buffer status frame may include or not include the L-part. When the PPDU does not include the L-part, the PPDU may be comprised only of the HE-SIG field (alternatively, the HE-SIG A and the HE-SIG B), the HE-STF, and the HE-LTF and when the PSDU additionally exists, the PPDU may include the data field.

Further, although not illustrated in S3101, the STA after the second order may receives the polling frame from the AP and thereafter, transmit the sounding and/or buffer status frame to the AP as illustrated in FIG. 28 or 29. For example, when the STA of the first order transmits the sounding and/or buffer status frame to the AP, the AP may transmit the polling frame to the STA of the second order and when the STA of the second order may receive the polling frame and thereafter, transmit the sounding and/or buffer status frame to the AP. The STAs after the third order may also perform the operation by the same scheme.

Thereafter, the AP may acquire the channel state information and/or buffer status information through the sounding and/or buffer status frame received from each STA. In addition, the AP may allocate the UL MU resources (for example, the stream for each STA in the case of the UL MU MIMO and the frequency/subcarrier for each STA in the case of the UL MU OFDMA) to each STA based on the acquired information.

General Apparatus to which the Present Invention May be Applied

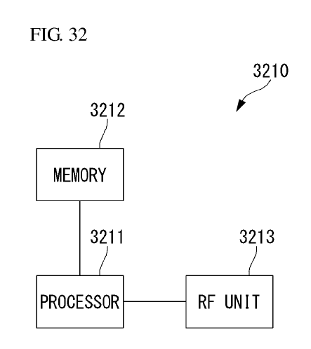

FIG. 32 is a block diagram exemplifying a wireless apparatus according to an embodiment of the present invention.

Referring to FIG. 32, an apparatus 3210 according to the present invention may include a processor 3211, a memory 3212, and a radio frequency (RF) unit 3213. The apparatus 3210 may be an AP or a non-AP STA for implementing the embodiments of the present invention.

The RF unit 3213 is connected to the processor 3211 to transmit and/receive a wireless signal. For example, the RF unit 3213 may implement the physical layer according to the IEEE 802.11 system.

The processor 3211 is connected to the RF unit 3213 to implement the physical layer and/or MAC layer according to the IEEE 802.11 system. The processor 3211 may be configured to perform the operations according to the various embodiments of the present invention according to FIGS. 1 to 31 above. In addition, a module that implements the operations of the AP and/or the STA according to the various embodiments of the present invention according to FIGS. 1 to 16 above may be stored in the memory 3212 and executed by the processor 3211.

The memory 3212 is connected to the processor 3211 and stores various pieces of information for driving the processor 3211. The memory 3212 may be included in the processor 3211, or installed exterior to the processor 3211 and connected to the processor 3211 with a known means.

Further, the apparatus 3210 may have a single antenna or multiple antennas.

Such a detailed configuration of the apparatus 3210 may be implemented such that the features described in various embodiments of the present invention described above are independently applied or two or more embodiments are simultaneously applied.

The embodiments described so far are those of the elements and technical features being coupled in a predetermined form. So far as there is not any apparent mention, each of the elements and technical features should be considered to be selective. Each of the elements and technical features may be embodied without being coupled with other elements or technical features. In addition, it is also possible to construct the embodiments of the present invention by coupling a part of the elements and/or technical features. The order of operations described in the embodiments of the present invention may be changed. A part of elements or technical features in an embodiment may be included in another embodiment, or may be replaced by the elements and technical features that correspond to other embodiment. It is apparent to construct embodiment by combining claims that do not have explicit reference relation in the following claims, or to include the claims in a new claim set by an amendment after application.

The embodiments of the present invention may be implemented by various means, for example, hardware, firmware, software and the combination thereof. In the case of the hardware, an embodiment of the present invention may be implemented by one or more application specific integrated circuits (ASICs), digital signal processors (DSPs), digital signal processing devices (DSPDs), programmable logic devices (PLDs), field programmable gate arrays (FPGAs), a processor, a controller, a micro controller, a micro processor, and the like.

In the case of the implementation by the firmware or the software, an embodiment of the present invention may be implemented in a form such as a module, a procedure, a function, and so on that performs the functions or operations described so far. Software codes may be stored in the memory, and driven by the processor. The memory may be located interior or exterior to the processor, and may exchange data with the processor with various known means.

It will be understood to those skilled in the art that various modifications and variations can be made without departing from the essential features of the inventions. Therefore, the detailed description is not limited to the embodiments described above, but should be considered as examples. The scope of the present invention should be determined by reasonable interpretation of the attached claims, and all modification within the scope of equivalence should be included in the scope of the present invention.

### INDUSTRIAL APPLICABILITY

In the wireless communication system, the example in which the uplink multi-user transmission method is applied to the IEEE 802.11 system is primarily described, but the uplink multi-user transmission method can be applied to various wireless communication systems in addition to the IEEE 802.11 system.

1. A method for transmitting multi-user uplink data in a wireless communication system, the method comprising:
receiving, by a station (STA), a sounding request frame from an access point (AP); and
transmitting, by the STA, a sounding frame to the AP in response to the sounding request frame,
wherein the sounding request frame includes information indicating the number of streams in which the STA needs to transmit the sounding frame, and
the sounding frame includes a long training field (LTF) symbols as many as the number of streams.

2. The method for transmitting multi-user uplink data of claim 1, wherein the sounding request frame includes information for the sounding request frame to indicate a sounding request for transmitting uplink data.

3. The method for transmitting multi-user uplink data of claim 2, wherein the sounding request frame includes information for indicating the sounding request for the uplink data transmission in a Modulation and Coding Scheme (MCS) feedback request (MRQ) subfield of a VHT control field.

4. The method for transmitting multi-user uplink data of claim 2, wherein the sounding request frame includes information for indicating the sounding request for the uplink data transmission in a Sounding Dialog Token field.

5. The method for transmitting multi-user uplink data of claim 1, wherein the sounding frame is constituted only by a High Efficiency STF (HE-STF), a High Efficiency LTF (HE-LTF), and a High Efficiency SIGNAL (HE-SIG) except for a Legacy-Short Training Field (L-STF), a Legacy-Long Training Field (L-LTF), and a Legacy SIGNAL (L-SIG) field.

6. The method for transmitting multi-user uplink data of claim 1, wherein the sounding request frame includes information for requesting buffer status information of the STA, and
the sounding frame includes the buffer status information of the STA.

7. The method for transmitting multi-user uplink data of claim 6, wherein the buffer status information include at least one information of access category (AC) of uplink data to be transmitted by the STA, the size of the uplink data, the size of a queue in which the uplink data are accumulated, a backoff count for the uplink data transmission, and a contention window for the uplink data transmission.

8. The method for transmitting multi-user uplink data of claim 1, wherein the sounding request frame is a Null Data Packet Announcement (NDPA) frame.

9. The method for transmitting multi-user uplink data of claim 1, wherein the sounding frame is a Null Data Packet (NDP).

10. A method for transmitting multi-user uplink data in a wireless communication system, the method comprising:
transmitting, by an access point (AP), a sounding request frame to a station (STA) which participates in transmitting the multi-user uplink data; and
receiving, by the AP, a sounding frame from the STA in response to the sounding request frame,
wherein the sounding request frame includes information indicating the number of streams in which the STA needs to transmit the sounding frame, and
the sounding frame includes long training fields (LTFs) as many as the number of streams.

11. The method for transmitting multi-user uplink data of claim 10, further comprising:
transmitting, by the AP, a polling frame to a second STA which participates in transmitting the multi-user uplink data in order to request transmitting the sounding frame; and
receiving, by the AP, the sounding frame from the second STA in response to the polling frame.

12. The method for transmitting multi-user uplink data of claim 10, further comprising:
allocating, by the AP, an uplink radio resource to the STA based on uplink channel information measured through the sounding frame.

13-14. (canceled)
